(19) United States
(12) Patent Application Publication
(10) Pub. No.: US 2018/0310017 A1
(43) Pub. Date: Oct. 25, 2018

(54) SUB-PREDICTION UNIT TEMPORAL MOTION VECTOR PREDICTION (SUB-PU TMVP) FOR VIDEO CODING

(71) Applicant: MEDIATEK INC., Hsin-Chu City (TW)

(72) Inventors: Chun-Chia Chen, Hsinchu (TW); Chih-Wei Hsu, Hsinchu (TW); Ching-Yeh Chen, Hsinchu (TW)

(73) Assignee: MEDIATEK INC., Hsin-Chu City (TW)

(21) Appl. No.: 15/954,294

(22) Filed: Apr. 16, 2018

Related U.S. Application Data
(60) Provisional application No. 62/488,092, filed on Apr. 21, 2017.

(51) Int. Cl. H04N 19/52; H04N 19/176; H04N 19/593; H04N 19/103

(52) U.S. Cl. CPC H04N 19/52; H04N 19/103; H04N 19/593; H04N 19/176

(57) ABSTRACT

Aspects of the disclosure provide a video coding method for processing a current prediction unit (PU) with sub-PU temporal motion vector prediction (TMVP) mode. The method can include performing sub-PU TMVP algorithms to derive sub-PU TMVP candidates, and including none or a subset of the derived sub-PU TMVP candidates into a merge candidate list of the current PU. Each of the derived sub-PU TMVP candidates can include sub-PU motion information of sub-PUs of the current PU.

### INCORPORATION BY REFERENCE

This present disclosure claims the benefit of U.S. Provisional Application No. 62/488,092, “A New Method for Diversity Based Sub-Block Merge Mode” filed on Apr. 21, 2017, which is incorporated herein by reference in its entirety.

### TECHNICAL FIELD

The present disclosure relates to video coding techniques.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

In image and video coding, pictures and their corresponding sample arrays can be partitioned into blocks using tree structure based schemes. Each block can be processed with one of multiple processing modes. Merge mode is one of such processing modes in which spatially or temporally neighboring blocks can share a same set of motion parameters. As a result, motion parameter transmission overhead can be reduced.

### SUMMARY

Aspects of the disclosure provide a video coding method for processing a current prediction unit (PU) with sub-PU temporal motion vector prediction (TMVP) mode. The method can include performing sub-PU TMVP algorithms to derive sub-PU TMVP candidates, and including none or a subset of the derived sub-PU TMVP candidates into a merge candidate list of the current PU. Each of the derived sub-PU TMVP candidates can include sub-PU motion information of sub-PUs of the current PU.

In one example, performing sub-PU TMVP algorithms to derive sub-PU TMVP candidates includes performing sub-PU TMVP algorithms to derive zero, one or more sub-PU TMVP candidates. In one example, more than one sub-PU TMVP candidates are derived from a same one of the sub-PU TMVP algorithms. In one example, at least two sub-PU TMVP algorithms are provided, and the performed sub-PU TMVP algorithms are a subset of the provided at least two sub-PU TMVP algorithms.

In an embodiment, the provided at least two sub-PU TMVP algorithms includes one of: (1) a first sub-PU TMVP algorithm, wherein an initial motion vector is a motion vector of a first available spatial neighboring block of the current PU; (2) a second sub-PU TMVP algorithm, wherein an initial motion vector is obtained by averaging motion vectors of spatial neighboring blocks of the current PU, or by averaging motion vectors of merge candidates before a sub-PU TMVP candidate being derived in the merge candidate list; (3) a third sub-PU TMVP algorithm, wherein a main collocated picture is determined to be a reference picture that is different from an original main collocated picture being found during a collocated picture search process; (4) a fourth sub-PU TMVP algorithm, wherein an initial motion vector is selected from a motion vector of a second available neighboring block of the current PU, or a motion vector of a first available neighboring block that is associated with a second list of the first available neighboring block, or motion vectors other than that of a first available neighboring block; or (5) a fifth sub-PU algorithm, wherein temporal collocated motion vectors of the sub-PUs of the current PU are averaged with motion vectors of spatial neighboring sub-PUs of the current PU.

In one example, in the second sub-PU TMVP algorithm, the spatial neighboring blocks of the current PU are one of: (1) a subset of blocks or sub-blocks at A0, A1, B0, B1, or B2 candidate positions specified in high efficiency video coding (HEVC) standards for merge mode; (2) a subset of sub-blocks at positions A0′, A1′, B0′, B1′, or B2′, wherein the positions A0′, A1′, B0′, B1′, or B2′ each correspond to a left-top corner sub-block of a spatial neighboring PU of the current PU which contains the position A0, A1, B0, B1, or B2, respectively; or (3) a subset of sub-blocks at A0, A1, B0, B1, B2, A0′, A1′, B0′, B1′, or B2′ positions. In one example, in the third sub-PU TMVP algorithm, the main collocated picture is determined to be a reference picture that is in an opposite direction from a current picture containing the current PU with respect to the original main collocated picture, and that has a picture order count (POC) distance to the current picture the same as a POC distance of the original main collocated picture to the current picture.

In one example, in the fourth sub-PU TMVP algorithm, selecting the initial motion vector includes one of: (1) a first process, wherein when the first spatial neighboring block is available and other spatial neighboring blocks are not available, the current fourth sub-PU TMVP algorithm terminates, and when the second spatial neighboring block is available, a motion vector of the second spatial neighboring block is selected to be the initial motion vector; (2) a second process, wherein (i) when the first spatial neighboring block is available and other spatial neighboring blocks are not available, and only one motion vector of the first spatial neighboring block is available, the current fourth sub-PU TMVP algorithm terminates, (ii) when the first spatial neighboring block is available and other spatial neighboring blocks are not available, and two motion vectors of the first spatial neighboring block associated with reference lists List 0 and List 1, respectively, are available, one of the two motion vectors associated with a second list of the first spatial neighboring block is selected to be the initial motion vector, and (iii) when the second spatial neighboring block is available, a motion vector of the second spatial neighboring block is selected to be the initial motion vector; or (3) a third process, wherein (i) when the first spatial neighboring block is available and other spatial neighboring blocks are not available, and only one motion vector of the first spatial neighboring block is available, the current fourth sub-PU TMVP algorithm terminates, (ii) when a first spatial neighboring block is available and other spatial neighboring blocks are not available, and two motion vectors of the first spatial neighboring block associated with reference lists List 0 and List 1, respectively, are available, one of the two motion vectors associated with a second list of the first spatial neighboring block is selected to be the initial motion vector, (iii) when the first and second spatial neighboring blocks are available, and two motion vectors of the first spatial neighboring block associated with reference lists List 0 and List 1, respectively, are available, one of the two motion vectors associated with a second list of the first spatial neighboring block is selected to be the initial motion vector, and (iv) when the first and second spatial neighboring blocks are available, and only one motion vector of the first spatial neighboring block is available, a motion vector of the second spatial neighboring block is selected to be the initial motion vector.

In one example, the fifth sub-PU TMVP algorithm includes obtaining collocated motion vectors for the sub-PUs of the current PU, averaging a motion vector of a top neighboring sub-PU of the current PU and a motion vector of a top row sub-PU of the current PU, and averaging a motion vector of a left neighboring sub-PU of the current PU and a motion vector of a left-most column sub-PU of the current PU.

Embodiments of the method can further include determining whether to include a current sub-PU TMVP candidate in a being-constructed merge candidate list into the merge candidate list of the current PU. The current sub-PU TMVP candidate can be to-be-derived with a respective sub-PU TMVP algorithm, or can be one of the derived sub-PU TMVP candidates. In one example, determining whether to include the current sub-PU TMVP candidate in the being-constructed merge candidate list into the merge candidate list of the current PU is based on at least one of a number of derived merge candidates before the current sub-PU TMVP candidate in the being-constructed candidate list, a similarity between the current sub-PU TMVP candidate and another one of the derived sub-PU TMVP candidates in the being-constructed merge candidate list, or a size of the current PU.

In one example, determining whether to include the current sub-PU TMVP candidate in the being-constructed merge candidate list into the merge candidate list of the current PU includes one of: (a) when a number of derived merge candidates that are before the current sub-PU TMVP candidate in the being-constructed candidate list and are not of sub-PU TMVP type exceeds a threshold, excluding the current sub-PU TMVP candidate from the merge candidate list; (b) when a number of derived merge candidates that are before the current sub-PU TMVP candidate in the being-constructed candidate list exceeds a threshold, excluding the current sub-PU TMVP candidate from the merge candidate list; (c) when a difference of the current sub-PU TMVP candidate and another one of the derived sub-PU TMVP candidates in the being-constructed merge candidate list is lower than a threshold, excluding the current sub-PU TMVP candidate from the merge candidate list; (d) when a size of the current PU is smaller than a threshold, excluding the current sub-PU TMVP candidate from the merge candidate list; (e) when a size of the current PU is larger than a threshold, excluding the current sub-PU TMVP candidate from the merge candidate list; or (f) determining whether to include the current sub-PU TMVP candidate in the merge candidate list according to a combination of two or more conditions considered in (a)-(e). In one embodiment, when the current sub-PU TMVP candidate is determined to be excluded from the merge candidate list of the current PU, performing the respective sub-PU TMVP algorithm to derive the current sub-PU TMVP candidate can be skipped.

In one example, a flag indicating whether to switch on or off operations of one or more of (a)-(f) is signaled from an encoder to a decoder. In one example, a threshold value of one or more thresholds of (a)-(e) is signaled from an encoder to a decoder. In one example, a flag indicating whether to switch on or off a sub-PU TMVP on-off switching control mechanism for determining whether to include a current sub-PU TMVP candidate in the being-constructed merge candidate list into the merge candidate list of the current PU is signaled from an encoder to a decoder.

Embodiments of the method can further include reordering a sub-PU TMVP merge candidate in a being-constructed merge candidate list or the merge candidate list of the current PU towards the front part of the being-constructed merge candidate list or the merge candidate list of the current PU. In one example, when a percentage of top and left neighboring sub-blocks of the current PU that have motion information derived with a sub-PU mode(s) is above a threshold, the sub-PU TMVP merge candidate at an original position in the being-constructed merge candidate list or the merge candidate list of the current PU is reordered to a position in front of the original position, or to a position at the front part of the being-constructed merge candidate list or the merge candidate list of the current PU. In one example, the sub-PU mode(s) includes one or more of an affine mode, a sub-PU TMVP mode, a spatial-temporal motion vector prediction (STMVP) mode, and a frame rate up conversion (FRUC) mode.

Aspects of the disclosure provide an video coding apparatus for processing a PU with sub-PU TMVP mode. The apparatus can include circuitry configured to perform sub-PU TMVP algorithms to derive sub-PU TMVP candidates, each of the derived sub-PU TMVP candidates including sub-PU motion information of sub-PUs of the current PU, and, and include none or a subset of the derived sub-PU TMVP candidates into a merge candidate list of the current PU.

Aspects of the disclosure provide a non-transitory computer readable medium. The medium stores instructions which, when executed by a processor, cause the processor to perform the method for processing a PU with sub-PU TMVP mode.

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows an example video encoder according to an embodiment of the disclosure;

FIG. 2 shows an example video decoder according to an embodiment of the disclosure;

FIG. 3 shows an example of spatial and temporal candidate positions for deriving motion vector predictor (MVP) candidates in an advanced motion vector prediction (AMVP) mode or for deriving merge candidates in a merge mode according to some embodiments of the disclosure;

FIG. 4 shows an example of a motion vector scaling operation according to some embodiments of the disclosure;

FIG. 5 shows an example process for processing a current PU with sub-PU TMVP mode according to some embodiments of the disclosure;

FIG. 6 shows an example process for processing a current block with a sub-PU TMVP mode according to some embodiments of the disclosure;

FIG. 7 shows an example merge candidate list constructed for processing a current PU with a sub-PU TMVP mode according to some embodiments of the disclosure;

FIG. 8 shows an example neighboring sub-block position according to an embodiment of the disclosure;

FIG. 9 shows an example of mixing motion vectors of sub-PUs of a current PU with motion vectors of spatial neighboring sub-PUs according to an embodiment of the disclosure; and

FIG. 10 shows an example of the sub-PU TMVP candidate on-off switching control mechanism according to an embodiment of the disclosure.

### DETAILED DESCRIPTION OF EMBODIMENTS

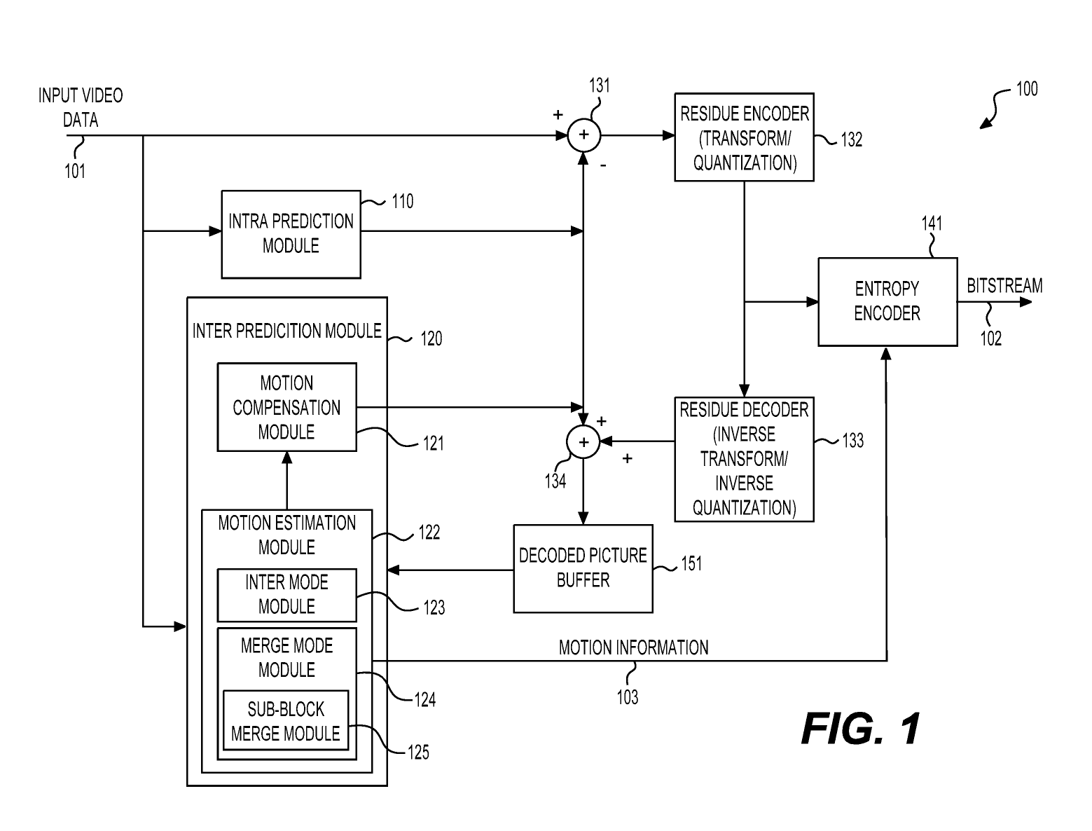

FIG. 1 shows an example video encoder 100 according to an embodiment of the disclosure. The encoder 100 can include an intra prediction module 110, an inter prediction module 120, a first adder 131, a residue encoder 132, an entropy encoder 141, a residue decoder 133, a second adder 134, and a decoded picture buffer 151. The inter prediction module 120 can further include a motion compensation module 121, and a motion estimation module 122. Those components can be coupled together as shown in FIG. 1.

The encoder 100 receives input video data 101 and performs a video compression process to generate a bitstream 102 as an output. The input video data 101 can include a sequence of pictures. Each picture can include one or more color components, such as a luma component or a chroma component. The bitstream 102 can have a format compliant with a video coding standard, such as the Advanced Video Coding (AVC) standards, High Efficiency Video Coding (HEVC) standards, and the like.

The encoder 100 can partition a picture in the input video data 101 into blocks, for example, using tree structure based partition schemes. In one example, the encoder 100 can partition a picture into coding units (CU) in a recursive way. For example, a picture can be partitioned into coding tree unit (CTU). Each CTU can be recursively split into four smaller CUs until a predetermined size is reached. CUs resulting from this recursive partition process can be square blocks but with different sizes.

The resulting blocks can then be processed with different processing modes, such as intra prediction modes, or inter prediction modes. In some examples, a resulting CU can be treated as a prediction unit (PU) and processed with a prediction mode. In some examples, a resulting CU can be further partitioned into multiple prediction units (PUs). A PU may include a block of luma samples and/or one or two blocks of chroma samples in some examples. Thus, PU and prediction block (PB) are used interchangeably in this specification for referring to a block of luma or chroma samples to be processed with a prediction coding mode. Generally, partition of a picture can be adaptive to local content of the picture. Accordingly, the resulting blocks (CUs or PUs) can have variable sizes or shapes at different locations of the picture.

In FIG. 1, the intra prediction module 110 can be configured to perform intra picture prediction to determine a prediction for a currently being processed block (referred to as a current block) during the video compression process. The intra picture prediction can be based on neighboring pixels of the current block within a same picture as the current block. For example, 35 intra prediction modes are specified in an HEVC standard.

The inter prediction module 120 can be configured to perform inter picture prediction to determine a prediction for a current block during the video compression process. For example, the motion compensation module 121 can receive motion information (motion data) of the current block from the motion estimation module 122. In one example, the motion information can include horizontal and vertical motion vector displacement values, one or two reference picture indices, and/or identification of which reference picture list is associated with each index. Based on the motion information and one or more reference pictures stored in the decoded picture buffer 151, the motion compensation module 121 can determine a prediction for the current block. For example, as specified in HEVC standards, two reference picture lists, List 0 and List 1, can be constructed for coding a B-type slice, and each list can include identifications (IDs) of a sequence of reference pictures. Each member of a list can be associated with a reference index. Thus, a reference index and a corresponding reference picture list together can be used in motion information to identify a reference picture in this reference picture list.

The motion estimation module 122 can be configured to determine the motion information for the current block and provide the motion information to the motion compensation module 122. For example, the motion estimation module 122 can process the current block with one of multiple inter prediction modes using the inter mode module 123 or the merge mode module 124. For example, the inter prediction modes can include an advanced motion vector prediction (AMVP) mode, a merge mode, a skip mode, a sub-PU temporal motion vector prediction (TMVP) mode, and the like.

When the current block is processed by the inter mode module 123, the inter mode module 123 can be configured to perform a motion estimation process searching for a reference block similar to the current block in one or more reference pictures. Such a reference block can be used as the prediction of the current block. In one example, one or more motion vectors and corresponding reference pictures can be determined as a result of the motion estimation process depending on unidirectional or bidirectional prediction method being used. For example, the resulting reference pictures can be indicated by reference picture indices, and, in case of bidirectional prediction is used, corresponding reference picture list identifications. As a result of the motion estimation process, a motion vector and an associated reference index can be determined for unidirectional prediction, or two motion vectors and two respective associated reference indices can be determined for bidirectional prediction. In addition, for bidirectional prediction, a reference picture list (either List 0 or List 1) corresponding to each of the associated reference indices can also be identified. Those motion information (including the determined one or two motion vectors, associated reference indices, and respective reference picture lists) are provided to the motion compensation module 121. In addition, those motion information can be included in motion information 103 that is transmitted to the entropy encoder 141.

In one example, the AMVP mode is used to predictively encode a motion vector at the inter mode module 123. For example, a motion vector predictor (MVP) candidate list can be constructed. The MVP candidate list can include a sequence of MVPs obtained from a group of spatial or temporal neighboring prediction blocks (PBs) of the current block. For example, motion vectors of spatial or temporal neighboring PBs at certain locations are selected and scaled to obtain the sequence of MVPs. A best MVP candidate can be selected from the MVP candidate list (which can be referred to as motion vector prediction competition) for predictively encoding a motion vector previously determined. As a result, a motion vector difference (MVD) can be obtained. For example, a MVP candidate having a best motion vector coding efficiency can be selected. Thus, when the AMVP mode is applied to the current block, a MVP index of the selected MVP candidate (referred to as MVP index) in the MVP candidate list and the respective MVD can be included in the motion information 103 and provided to the entropy encoder 141 in place of the respective motion vector.

When the current block is processed by the merge mode module 124, the merge mode module 124 can be configured to perform operations of a merge mode to determine the set of motion data of the current block that is provided to the motion compensation module 121. For example, a subset of candidate blocks can be selected from a set of spatial and temporal neighboring blocks of the current block located at predetermined candidate positions. For example, the temporal neighboring blocks can be located at a predetermined reference picture, such as a first reference picture at a reference picture list, List 0 or List 1, of the current block (or current picture containing the current block). Then, a merge candidate list can be constructed based on the selected subset of temporal or spatial candidate blocks. The merge candidate list can include multiple entries. Each entry can include motion information of a candidate block. For a temporal candidate block, the respective motion information (motion vectors) can be scaled before listed into the merge candidate list. In addition, motion information in the merge candidate list corresponding to a temporal candidate block can have a reference index that is set to 0 (meaning a first picture in List 0 or list 1 is used as the reference picture).

Subsequently, a best merge candidate in the merge candidate list can be selected and determined to be the motion information of the current block (prediction competition). For example, each entry can be evaluated assuming the respective entry is used as motion information of the current block. A merge candidate having highest rate-distortion performance can be determined to be shared by the current block. Then, the to-be-shared motion information can be provided to the motion compensation module 121. In addition, an index of the selected entry that includes the to-be-shared motion data in the merge candidate list can be used for indicating and signaling the selection. Such an index is referred to as a merge index. The merge index can be included in the motion information 103 and transmitted to the entropy encoder 141.

In alternative examples, a skip mode can be employed by the inter prediction module 120. For example, in skip mode, a current block can be predicted similarly using a merge mode as described above to determine a set of motion data, however, no residue is generated or transmitted. A skip flag can be associated with the current block. The skip flag can be signaled to a video decoder. At the video decoder side, a prediction (a reference block) determined based on the merge index can be used as a decoded block without adding residue signals.

In further examples, the sub-PU TMVP mode can be used as a part of the merge mode to process the current block (thus, sub-PU TMVP mode can also be referred to as sub-PU TMVP merge mode). For example, the merge mode module 124 can include a sub-block merge module 125 that is configured to perform operations of the sub-PU TMVP mode. In operations of the sub-PU TMVP mode, for example, the current block can be further partitioned into a set of sub-blocks. Temporal collocated motion vectors of each sub-block can then be obtained, scaled, and used as motion vectors of the sub-blocks. Those resulting motion vectors can be counted as a merge candidate (referred to as a sub-PU TMVP merge candidate, or sub-PU candidate) and listed in the merge candidate list. In addition, in some examples, a reference picture index associated with the resulting motion vectors are set to 0 corresponding to a reference picture list, List 0 or List 1. During the merge candidate evaluation process as described above, if the sub-PU candidate is selected (prediction competition), a merge index corresponding to the sub-PU merge candidate can be generated and transmitted in the motion information 103. The sub-PU candidate can also be provided to the motion compensation module 121 that generates a prediction of the current block based on the sub-PU candidate.

Multiple processing modes are described above, such as intra prediction mode, AMVP mode, merge mode, sub-PU TMVP mode, and skip mode. Generally, different blocks can be processed with different processing modes, and a mode decision needs to be made regarding which processing modes are to be used for one block. For example, the mode decision can be based on test results of applying different processing modes on one block. The test results can be evaluated based on rate-distortion performance of respective processing modes. A processing mode having a best result can be determined as the choice for processing the block. In alternative examples, other methods or algorithms can be employed to determine a processing mode. For example, characteristics of a picture and blocks partitioned from the picture may be considered for determination of a processing mode.

The first adder 131 receives a prediction of a current block from either the intra prediction module 110 or the motion compensation module 121, and the current block from the input video data 101. The first adder 131 can then subtract the prediction from pixel values of the current block to obtain a residue of the current block. The residue of the current block is transmitted to the residue encoder 132.

The residue encoder 132 receives residues of blocks, and compresses the residues to generate compressed residues. For example, the residue encoder 132 may first apply a transform, such as a discrete cosine transform (DCT), discrete sine transform (DST), wavelet transform, and the like, to received residues corresponding to a transform block and generate transform coefficients of the transform block. Partition of a picture into transform blocks can be the same as or different from partition of the picture into prediction blocks for inter or intra prediction processing. Subsequently, the residue encoder 132 can quantize the coefficients to compress the residues. The compressed residues (quantized transform coefficients) are transmitted to the residue decoder 133 and the entropy encoder 141.

The residue decoder 133 receives the compressed residues and performs an inverse process of the quantization and transformation operations performed at the residue encoder 132 to reconstruct residues of a transform block. Due to the quantization operation, the reconstructed residues are similar to the original residues generated from the adder 131 but typically are not the same as the original version.

The second adder 134 receives predictions of blocks from the intra prediction module 110 and the motion compensation module 121, and reconstructed residues of transform blocks from the residue decoder 133. The second adder 134 subsequently combines the reconstructed residues with the received predictions corresponding to a same region in the current picture to generate reconstructed video data. The reconstructed video data can be stored into the decoded picture buffer 151 forming reference pictures that can be used for the inter prediction operations.

The entropy encoder 141 can receive the compressed residues from the residue encoder 132, and the motion information 103 from the motion estimation module 122. The entropy encoder 141 can also receive other parameters and/or control information, such as intra prediction or inter prediction mode information, quantization parameters, and the like. The entropy encoder 141 encodes the received parameters or information to form the bitstream 102. The bitstream 102 including data in a compressed format can be transmitted to a decoder via a communication network, or transmitted to a storage device (e.g., a non-transitory computer-readable medium) where video data carried by the bitstream 102 can be stored.

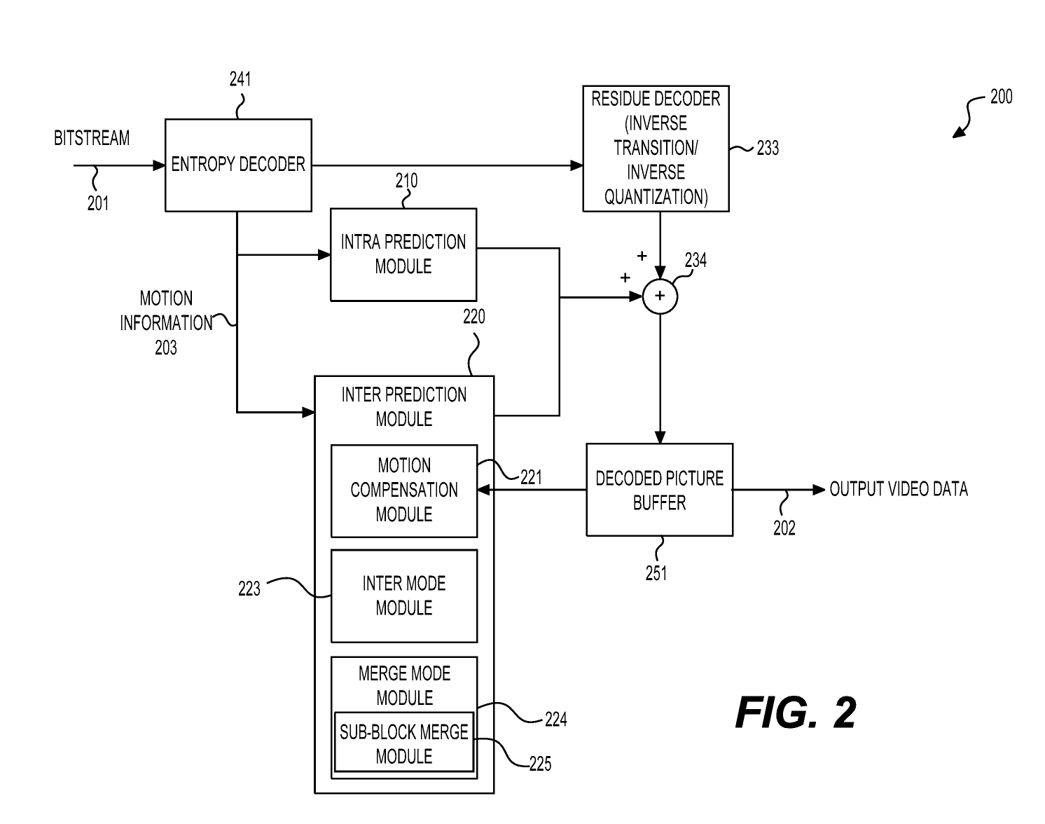

FIG. 2 shows an example video decoder 200 according to an embodiment of the disclosure. The decoder 200 can include an entropy decoder 241, an intra prediction module 210, an inter prediction module 220 that includes a motion compensation module 221, an inter mode module 223, and a merge mode module 224, a residue decoder 233, an adder 234, and a decoded picture buffer 251. Those components are coupled together as shown in FIG. 2. In one example, the decoder 200 receives a bitstream 201, such as the bitstream 102 from the encoder 100, and performs a decompression process to generate output video data 202. The output video data 202 can include a sequence of pictures that can be displayed, for example, on a display device, such as a monitor, a touch screen, and the like.

The entropy decoder 241 receives the bitstream 201 and performs a decoding process which is an inverse process of the encoding process performed by the entropy encoder 141 in FIG. 1 example. As a result, motion information 203, intra prediction mode information, compressed residues, quantization parameters, control information, and the like, are obtained. The compressed residues and the quantization parameters can be provided to the residue decoder 233.

The intra prediction module 210 can receive the intra prediction mode information and accordingly generate predictions for blocks encoded with intra prediction mode. The inter prediction module 220 can receive the motion information 203 from the entropy decoder 241, and accordingly generate predictions for blocks encoded with the AMVP mode, merge mode, sub-PU TMVP mode, skip mode, or the like. The generated predictions are provided to the adder 234.

For example, for a current block encoded with the AMVP mode, the inter mode module 223 can receive a MVP index and a MVD corresponding to the current block. The intra mode module 223 can construct a MVP candidate list in a same manner as the intra mode module 123 at the video encoder 100 in FIG. 1 example. Using the MVP index and based on the constructed MVP candidate list, a MVP candidate can be determined. A motion vector can subsequently be derived by combining the MVP candidate with the MVD, and provided to the motion compensation module 221. In combination with other motion information, such as reference indexes, respective reference picture lists, and based on reference pictures stored in the decoded picture buffer 251, the motion compensation module 221 can generate a prediction of the current block.

For a block encoded with the merge mode, the merge mode module 224 can obtain a merge index from the motion information 203. In addition, the merge mode module 224 can construct a merge candidate list in a same manner as the merge mode module 124 at the video encoder 100 in FIG. 1 example. Using the merge index and based on the constructed merge candidate list, a merge candidate can be determined and provided to the motion compensation module 221. The motion compensation module 221 can accordingly generate a prediction of the current block.

In one example, the received merge index can indicate sub-PU TMVP mode is applied to the current block. For example, the merge index is within a predefined range for representing sub-PU candidates, or the merge index is associated with a special flag. Accordingly, sub-PU TMVP mode related operations can be performed at a sub-block merge module 225 to derive a respective sub-PU merge candidate corresponding to the merge index. For example, the sub-block merge module 225 can obtain the sub-PU merge candidate in a same manner as the sub-block merge module 125 at the video encoder 100 in FIG. 1 example. The derived sub-PU merge candidate can then be provided to the motion compensation module 221. The motion compensation module 221 can accordingly generate a prediction of the current block.

The residue decoder 233, and the adder 234 can be similar to the residue decoder 133 and the second adder 134 in the FIG. 1 example in terms of functions and structures. Particularly, for blocks encoded with skip mode, no residues are generated for those blocks. The decoded picture buffer 251 stores reference pictures useful for motion compensation performed at the motion compensation module 221. The reference pictures, for example, can be formed by reconstructed video data received from the adder 234. In addition, reference pictures can be obtained from the decoded picture buffer 251 and included in the output video data 202 for displaying to a display device.

In various embodiments, the components of the encoder 100 and decoder 200 can be implemented with hardware, software, or combination thereof. For example, the merge modules 124 and 224 can be implemented with one or more integrated circuits (ICs), such as an application specific integrated circuit (ASIC), field programmable gate array (FPGA), and the like. For another example, the merge modules 124 and 224 can be implemented as software or firmware including instructions stored in a computer readable non-volatile storage medium. The instructions, when executed by a processing circuit, causing the processing circuit to perform functions of the merge modules 124 or 224.

It is noted that the merge modules 124 and 224 can be included in other decoders or encoders that may have similar or different structures from what is shown in FIG. 1 or FIG. 2. In addition, the encoder 100 and decoder 200 can be included in a same device, or separate devices in various examples.

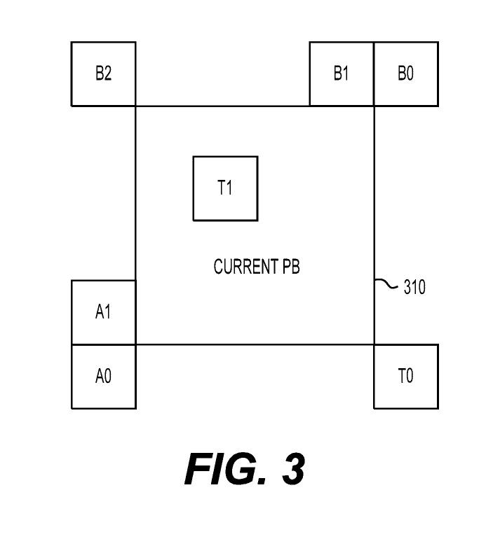

FIG. 3 shows an example of spatial and temporal candidate positions for deriving MVP candidates in an AMVP mode or for deriving merge candidates in a merge mode according to some embodiments of the disclosure. The candidate positions in FIG. 3 are similar to that specified in HEVC standards for merge mode or AMVP mode. As shown, a PB 310 is to be processed with the AMVP mode or the merge mode. A set of candidate positions {A0, A1, B0, B1, B2, T0, T1} are predefined. Specifically, candidate positions {A0, A1, B0, B1, B2} are spatial candidate positions that represent positions of spatial neighboring blocks of the PB 310 that are in the same picture as the PB 310. In contrast, candidate positions {T0, T1} are temporal candidate positions that represent positions of temporal neighboring blocks that are in a collocated picture. The collocated picture is assigned according to a header. In some embodiments, the collocated picture is a reference picture in a reference list L0 or L1.

In FIG. 3, each candidate position is represented by a block of samples, for example, having a size of 4×4 samples. In some embodiments, a size of such a block can be equal to or smaller than a minimum allowed size of PBs (e.g., 4×4 samples) defined for a tree-based partitioning scheme used for generating the PB 310. Under such configuration, a block representing a candidate position can always be covered within a single neighboring PB. In alternative example, a sample position may be used to represent a candidate position.

During a MVP candidate list or merge candidate list construction process, motion information of neighboring PBs at the candidate positions can be selected to be MVP or merge candidates and included in the MVP or merge candidate list. In some scenarios, a MVP or merge candidate at a candidate position may be unavailable. For example, a candidate block at a candidate position can be intra-predicted, or can be outside of a slice including the current PB 310 or is not in a same CTB row as the current PB 310. In some scenarios, a merge candidate at a candidate position may be redundant. For example, the motion information of the merge candidate is the same as the motion information of another candidate in the MVP candidate list or the merge candidate list, which may be taken as redundant candidates. The redundant merge candidate can be removed from the candidate list in some examples.

In one example, in the AMVP mode, a left MVP can be a first available candidate from positions {A0, A1}, a top MVP can be a first available candidate from positions {B0, B1, B2}, and a temporal MVP can be a first available candidate from positions {T0, T1} (T0 is used first. If T0 is not available, T1 is used instead). As an example, a MVP candidate list size is set to 2 in HEVC standards. Therefore, after the derivation process of the two spatial MVPs and one temporal MVP, the first two MVPs can be included in the MVP candidate list. If after removing redundancy, the number of available MVPs is less than two, zero vector candidates can be added to the MVP candidates list.

In one example, for a merge mode, up to four spatial merge candidates are derived from positions {A0, A1, B0, B1}, and one temporal merge candidate is derived from positions {T0, T1} (T0 is used first. If T0 is not available, T1 is used instead). If any of the four spatial merge candidates is not available, the position B2 is then used to derive a merge candidate as a replacement. After the derivation process of the four spatial merge candidate and one temporal merge candidate, removing redundancy can be applied to remove redundant merge candidate. If after removing redundancy, the number of available merge candidate is smaller than a predefined merge candidate list size (such as 5 in an example), additional candidates can be derived and added to the merge candidates list. In some examples, the additional candidates can include the following three candidate types: combined bi-predictive merge candidate, scaled bi-predictive merge candidate, and zero vector merge candidate.

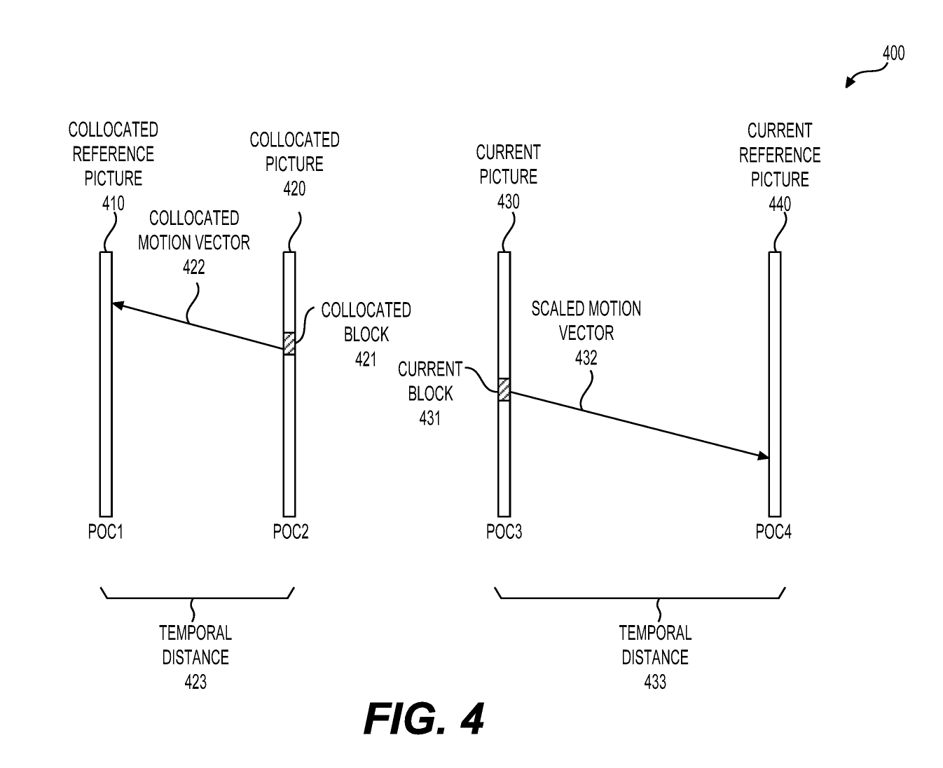

FIG. 4 shows an example of a motion vector scaling operation 400 according to some embodiments of the disclosure. By performing the motion vector scaling operation 400, a scaled motion vector 432 can be derived from a collocated motion vector 422. Specifically, the scaled motion vector 432 is associated with a current picture 430 and a current reference picture 440. The scaled motion vector 432 can be used to determine a prediction for a current block 431 in the current picture 430. In contrast, the collocated motion vector 422 is associated with a collocated picture 420 and a collocated reference picture 410. The collocated motion vector 422 can be used to determine a prediction for a collocated block 421 in the collocated picture 420. Additionally, the pictures 410-440 can each be assigned a picture order count (POC) value, POC 1-POC 4 indicating an output position (or a presentation time) relative to other pictures in a video sequence.

Particularly, the collocated block 421 can be a temporal neighboring block of the current block 431. For example, the collocated block 421 can be a temporal neighboring block at the candidate positions T0 or T1 in FIG. 3 for the AMVP mode or merge mode. In addition, corresponding to the AMVP mode, the current reference picture 440 can be a reference picture of the current block 431 determined by a motion estimation operation. Corresponding to the merge mode, the current reference picture 440 can be a reference picture preconfigured for temporal merge candidates, for example, a first reference picture (reference index equals zero) in a reference picture list, List 0 or List 1, of the current block 431.

For motion vector scaling operations, it can be assumed that a value of a motion vector is proportional to a temporal distance in presentation time between two pictures associated with the motion vector. Based on the assumption, the scaled motion vector 432 can be obtained by scaling the collocated motion vector 422 based on two temporal distances. For example, as shown in FIG. 4, a first temporal distance 433 can be a difference of POC 3-POC4, and a second temporal distance 423 can be a difference of POC 2-POC 1. Accordingly, a vertical or horizontal displacement value of the scaled motion vector MVS_x, or MVS_y can be calculated using the following expressions:

$${MVS}_{—} x = \frac{POC 3 - POC 4}{POC 2 - POC 1} {MVC}_{—} x , \\ {MVS}_{—} y = \frac{POC 3 - POC 4}{POC 2 - POC 1} {MVC}_{—} y ,$$

where MVC_x and MVC_y are vertical and horizontal displacement values of the collocated motion vector 422. In alternative examples, motion scaling operation may be performed in a way different from what is described above. For example, expressions different from the above expressions may be used and additional factors may be considered.

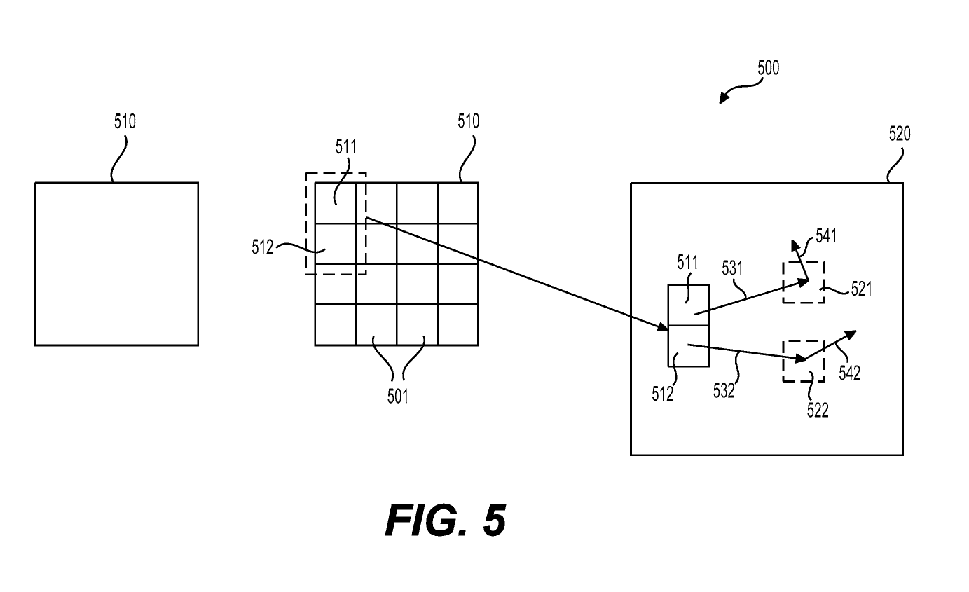

FIG. 5 shows an example process 500 for processing a current PU 510 with sub-PU TMVP mode according to some embodiments of the disclosure. The process 500 can be performed to determine a set of merge candidates (motion information) for sub-blocks of the current PU 500. The process 500 can be performed at the sub-block merge module 125 in the video encoder 100 in FIG. 1 example, or at the sub-block merge module 225 in the video decoder 200 in FIG. 2 example.

Specifically, the current PU 510 can be partitioned into sub-PUs 501. For example, the current PU 510 can have a size of M×N pixels, and be partitioned into (M/P)×(N/Q) sub-PUs 501 where M is divisible by P, and N is divisible by Q. Each resulting sub-PU 501 is of a size of P×Q pixels. For example, a resulting sub PU 501 can have a size of 8×8, 4×4, or 2×2 pixels.

Then, a reference picture 520, referred to as temporal collocated picture 520, can be determined. Next, a motion vector for each sub-PU 501, referred to as an initial sub-PU motion vector, can be determined. Thereafter, a set of temporal collocated sub-PUs (that are temporal neighboring blocks of the sub-PUs 501) can be determined. The set of temporal collocated sub-PUs (each corresponding to a sub-PU 501) can be located at the temporal collocated picture 520 using the initial sub-PU motion vectors.

Examples of sub-PU 511-512 are shown in FIG. 5. As shown, the sub-PU 511 has an initial sub-PU motion vector 531 towards a respective temporal collocated sub-PU 521. The sub-PU 512 has an initial sub-PU motion vector 532 towards a respective temporal collocated sub-PU 522.

Subsequently, motion information of determined temporal collocated sub-PUs is obtained for the PU 510. For example, motion information of the temporal collocated sub-PU 521 can be used for deriving a motion vector of the sub-PU 511. For example, the motion information of the temporal collocated sub-PU 521 may include a motion vector 541, an associated reference index, and optionally a reference picture list corresponding to the associated reference index. Similarly, motion information (including a motion vector 542) of the temporal collocated sub-PU 522 can be used for deriving a motion vector of the sub-PU 512.

In alternative examples of the process 500 for processing the current PU 510 with sub-PU TMVP mode, operations can be different from the above descriptions. For example, in various examples, different sub-PUs 501 may use different temporal collocated pictures, and methods for determining the temporal collocated pictures can vary. In addition, methods for determining initial sub-PU motion vectors can vary. In one example, initial sub-PU motion vectors of the sub-PUs can use a same motion vector.

As can be seen, the sub-PU TMVP mode enables detailed motion information of a plurality of sub-PUs to be derived and utilized for encoding a current block. In contrast, in conventional merge mode, a current block is treated as a whole and a merge candidate is used for a whole current block. As a result, a sub-PU TMVP mode can potentially provide more accurate motion information than a traditional merge mode for sub-PUs, thus improving video coding efficiency.

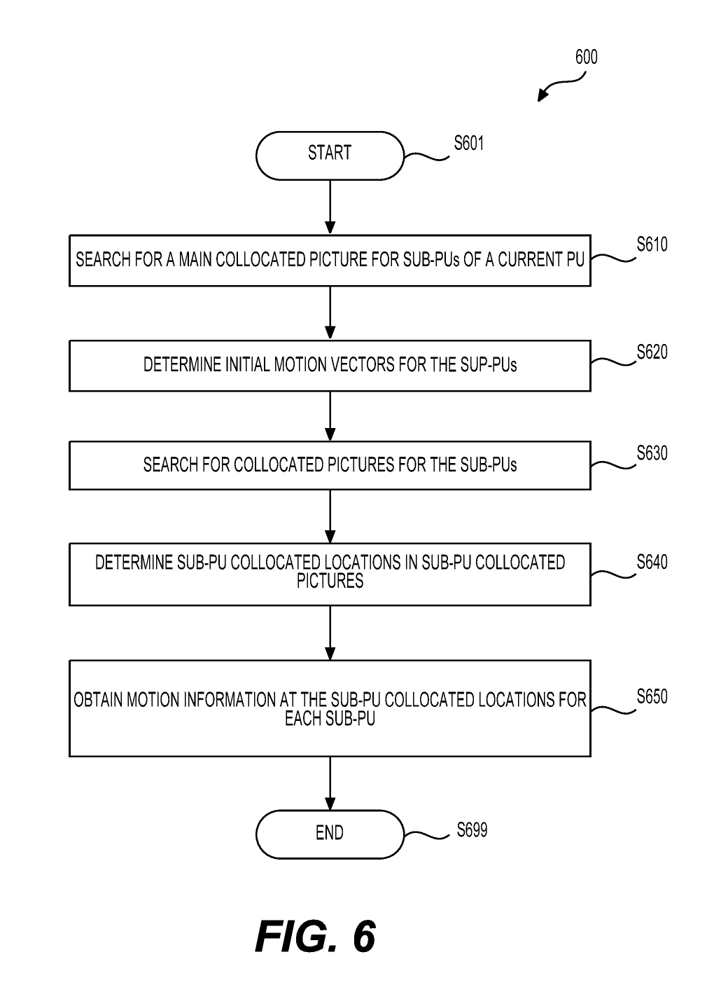

FIG. 6 shows an example process 600 for processing a current block with a sub-PU TMVP mode according to some embodiments of the disclosure. The process 600 can be performed at the sub-block merge module 125 in the video encoder 100 in FIG. 1 example, or at the sub-block merge module 225 in the video decoder 200 in FIG. 2 example. The process 600 starts at S601 and proceeds to S610.

At S610, a reference picture (referred to as a main collocated picture) for sub-PUs of the current PU is determined during a search process. First, the sub-block merge module 125 or 225 can find an initial motion vector for the current PU. The initial motion vector can be denoted as vec_init. In one example, the vec_init can be a motion vector from a first available spatial neighboring block such as one of the neighboring blocks at one of the positions {A0, A1, B0, B1, B2} in FIG. 3 example.

In one example, the vec_init is a motion vector associated with a reference picture list of the first available spatial neighboring block that is first searched during the search process. For example, the first available spatial neighboring block is in a B-slice, and can have two motion vectors associated with different reference picture lists, List 0 and List 1. The two motion vectors are referred to as List 0 motion vector and List 1 motion vector, respectively. During the search process, one of List 0 and List 1 is first searched (as described below) for the main collocated picture, and the other one is searched subsequently. The one (List 0 or List 1) being searched firstly is referred to a first list, and the one being searched secondly is referred to as a second list. Therefore, among the List 0 motion vector and the List 1 motion vector, the one associated with the first list can be used as the vec_init.

For example, List X is the first list for searching collocated information (collocated picture), then the vec_init uses List 0 motion vector if List X=List 0, and uses List 1 motion vector if List X=List 1. The value of List X (List 0 or List 1) depends on which list (List 0 or List 1) is better for collocated information. If List 0 is better for collocated information (e.g., a POC distance is closer than List 1), then List X=List 0, and vice versa. List X assignment can be at slice level or picture level. In alternative examples, the vect_init may be determined using different methods.

After the initial motion vector of the current PU is determined, a collocated picture searching process can start to search for the main collocated picture. The main collocated picture is denoted as main_colpic. The collocated picture searching process is to find the main collocated picture for sub-PUs of the current PU. During the collocated picture searching process, reference pictures of the current PU are searched and investigated, and one of the reference pictures is selected to be the main_colpic. In various examples, the searching processes can be carried out in different ways. For example, reference pictures can be investigated with different methods (e.g. with or without a motion vector scaling operation). Or, orders for searching the reference pictures can vary.

In one example, the searching is carried out in the following order. First, a reference picture selected by the first available spatial neighboring block (the reference picture associated with the initial motion vector) is searched. Then, in B-Slices, all reference pictures of the current PU can be searched, starting from one reference picture list, List 0 (or List 1), reference index 0, then index 1, then index 2, and so on (increasing index order). If the searching on List 0 (or List 1) is completed without finding a valid main collocated picture, another list, List 1 (or List 0) can be searched. In P-slice, the reference pictures of current PU in List 0 can be searched, starting from reference index 0, then index 1, then index 2, and so on (increasing index order).

During the search for the main collocated picture, reference pictures are investigated to determine if the being-investigated picture is valid or available. Thus, this investigation of each reference picture is also referred to as an availability checking. In some examples, the investigation can be performed in the following way for each searched picture (being-investigated picture) except the reference picture associated with the initial motion vector. In a first step, a motion vector scaling operation can be performed. By the motion vector scaling operation, the initial motion vector is scaled resulting in a scaled motion vector, denoted as vec_init_scaled, corresponding to the being-investigated reference picture. The scaling operation can be based on a first temporal distance between the current picture (including the current PU and the first available spatial neighboring block) and the reference picture associated with the initial motion vector, and a second temporal distance between the current picture and the being-investigated reference picture. For the first being-investigated picture (that is the reference picture associated with initial motion vector), no scaling operation is performed.

In some examples, before the motion vector scaling operation is performed, a decision of whether to perform a motion vector scaling can be determined. For example, whether a being-investigated reference picture in List 0 or List 1 and the reference picture associated with the initial motion vector are a same picture is examined. When the reference picture associated with the initial motion vector and the being-investigated reference picture are the same picture, the motion vector scaling can be skipped, and the investigation of this being-investigated picture can be finished. In opposite situation, the scaling operation can be performed as described above.

Below are two examples of examining whether a being-investigated reference picture in List 0 or List 1 and the reference picture associated with the initial motion vector are a same picture. In a first example, when a reference index associated with the initial motion vector of the first available spatial neighboring block is not equal to a reference index of a being-investigated reference picture, the scaling operation can be performed. In another example, POC values of the reference picture associated with the initial motion vector and the reference picture being-investigated can be examined. When the POC values are different, the scaling operation can be performed.

In a second step of the investigation, a checking position in the being-investigated picture is determined based on the scaled initial motion vector, and is checked whether the checking position is inter coded (processed with an inter prediction mode) or intra coded (processing with an intra prediction mode). If the checking position is inter coded (availability checking is successful), the being-investigated picture can be used as the main collocated picture, and the searching process can stop. If the checking position is intra coded (availability checking is failed), the search can continue to investigate a next reference picture.

In one example, an around center position of the current PU is added with vec_init_scaled to determine the checking position in the being-investigated picture. The around center position can be determined in various ways in different examples. In one example, the around center position can be a center pixel. For example, for the current PU of size M×N pixels, the around center position can be position (M/2, N/2). In one example, the around center position can be a center sub-PU's center pixel in the current PU. In one example, the around center position can be a position around the center of the current PU other than positions in the former two examples. In alternative examples, the checking position may be defined and determined in a different way.

For the reference picture associated with the initial motion vector, an around center position of the current PU can be added with vec_init (instead of vec_init_scaled) to determine the checking position.

At S620, initial motion vectors for sub-PUs of the current PU can be determined. For example, the current PU of a size of M×N pixels can be partitioned into sub-PUs of a size of P×Q pixels. A sub-PU initial motion vector can be determined for each sub-PU. A sub-PU initial motion vector for the i-th sub-PU can be denoted as vec_init_sub_i (i=0˜((M/P)×(N/Q)−1)). In one example, the sub-PU initial motion vectors equal the scaled initial motion vector corresponding to the main collocated picture found at S610 (vec_init_sub_i=vec_init_scaled). In one example, the sub-PU initial motion vectors, vec_init_sub_i(i=0˜((M/P)×(N/Q)−1)) may be different with each other, and can be derived based one or more spatial neighboring PUs of the current block, or with other suitable methods.

At S630, collocated pictures for the sub-PUs, referred to as sub-PU collocated pictures, can be searched for. For example, for each sub-PU, a sub-PU collocated picture from reference picture List 0 and a sub-PU collocated picture from reference picture List 1 can be found. In one example, there is only one collocated picture (using the main_colpic as described above) for reference picture List 0 for all sub-PUs of the current PU. In one example, sub-PU collocated pictures for reference picture List 0 for all sub-PUs may be different. In one example, there is only one collocated picture (using main_colpic as described earlier) for reference picture List 1 for all sub-PUs of the current PU. In one example, sub-PU collocated pictures for reference picture List 1 for all sub-PUs may be different. The sub-PU collocated picture for reference picture List 0 for the i-th sub-PU can be denoted as collocated_picture_i_L0, and sub-PU collocated picture for reference picture List 1 for the ith-sub-PU can be denoted as collocated_picture_i_L1. In one example, the main_colpic is used for all sub-PUs of the current PU for both List 0 and List 1.

At S640, sub-PU collocated locations in sub-PU collocated pictures can be determined. For example, a collocated location in a sub-PU collocated picture can be found for a sub-PU. In one example, the sub-PU collocated location can be determined according to the following expressions:

collocated location x=sub-PU_i_x+vec_init_sub_i_x(integer part)+shift_x,

collocated location y=sub-PU_i_y+vec_init_sub_i_y(integer part)+shift_y,

where sub-PU_i_x represents a horizontal left-top location of the i-th sub-PU inside the current PU (integer location), sub-PU_i_y represents vertical left-top location of the i-th sub-PU inside the current PU (integer location), vec_init_sub_i_x represents a horizontal part of vec_init_sub_i (vec_init_sub_i can have an integer part and a fractional part in the calculation, and the integer part is used), vec_init_sub_i_y represents a vertical part of vec_init_sub_i (similarly, integer part is used), shift_x represents a first shift value, and shift_y means a second shift value. In one example, shift_x can be a half of a sub-PU width, and shift_y can be a half of a sub-PU height. In alternative examples, the shift_x or shift_y may take other suitable values.

At S650, motion information at the sub-PU collocated locations can be obtained for each sub-PU. For example, motion information as a temporal predictor for the i-th sub-PU, denoted as subPU_MI_i, can be obtained for each sub-PU from respective sub-PU collocated pictures. The subPU_MI_i can be motion information from collocated_picture_i_L0 and collocated_picture_i_L1 on collocated location x and collocated location y. In one example, a subPU_MI_i can be defined as the set of {MV_x, MV_y, associated reference lists, associated reference indexes, and other merge-mode-sensitive information, such as a local illumination compensation flag}. MV_x and MV_y represent horizontal and vertical motion vector displacement values of motion vectors at collocated location x and collocated location y in collocated_picture_i_L0 and collocated_picture_i_L1 of the i-th sub-PU.

In addition, in some examples, MV_x and MV_y may be scaled according to a temporal distance relation between collocated picture, current picture, and reference picture of the collocated motion vector (MV). For example, a sub-PU in a current picture can have a first reference picture (such as a first reference picture in List 0 or List 1), and have a sub-PU collocated picture including a collocated motion vector of the sub-PU. The collocated motion vector can be associated with a second reference picture. Accordingly, the collocated motion vector can be scaled to obtain a scaled motion vector based on a first temporal distance between the current picture and the first reference picture, and a second temporal distance between the sub-PU collocated picture and the second reference picture. The process 600 can proceed to S699 and terminates at S699.

I. Method of Multiple Sub-PU TMVP Merge Candidates

In order to improve coding efficiency, in some embodiments, a multiple sub-PU TMVP merge candidates method is employed in sub-PU TMVP mode. The main idea of the multiple sub-PU TMVP merge candidates method is that, instead of having only one sub-PU TMVP candidate in a merge candidate list, multiple sub-PU TMVP merge candidates can be inserted into one candidate list. Moreover, algorithms for deriving each sub-PU TMVP candidate, referred to as sub-PU TMVP algorithms, can be different from each other. For example, the process 600 in FIG. 6 example can be one of such sub-PU TMVP algorithms. Employment of more than one sub-PU TMVP candidates can increase diversity of merge candidates, and can increasing possibility of selecting a better merge candidate, thus increasing coding efficiency.

In one example, N_S number of sub-PU TMVP candidates can be inserted into a merge candidate list. There are a total of M_C candidates in the merge candidate list, and M_C>N_S. A set of sub-PU TMVP algorithms for deriving each sub-PU TMVP candidate i (i=1, 2, . . . , N_S) is denoted as algo_i. For different sub-PU TMVP candidates, for example, sub-PU TMVP candidate i and sub-PU TMVP candidate j (i and j are different), algo_i can be different from algo_j.

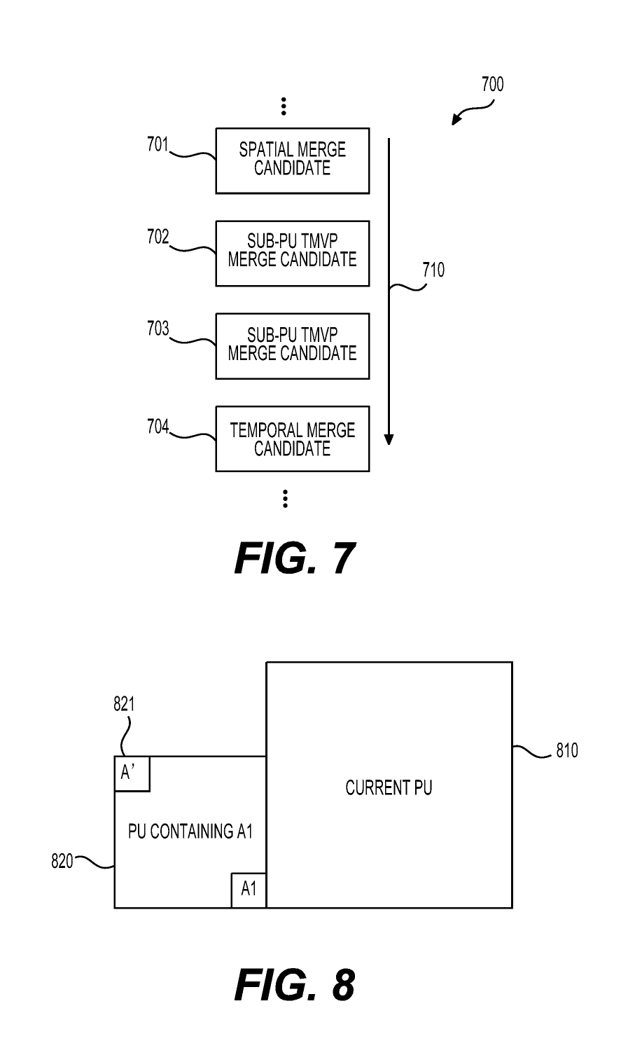

FIG. 7 shows an example merge candidate list 700 constructed for processing a current PU with a sub-PU TMVP mode according to some embodiments of the disclosure. The sub-PU TMVP mode employs the multiple sub-PU TMVP merge candidates method to derive multiple sub-PU TMVP candidates in the merge candidate list 700. The merge candidate list 700 can include a sequence of merge candidates. Each merge candidate can be associated with a merge index. The sequence of merge candidates can be arranged in a merge index increasing order as indicated by an arrow 710.

A portion of the merge candidate list 700 includes a spatial merge candidate 701, a first sub-PU TMVP merge candidate 702, a second sub-PU TMVP merge candidate 703, and a temporal merge candidate 704. The spatial and temporal merge candidates 701 and 704 can be derived with a traditional merge mode similar to that described in FIG. 3 example. For example, the spatial merge candidate 701 can be merge information of a spatial neighboring PU of the current PU, while the temporal candidate 704 can be merge information of a temporal neighboring PU of the current PU (scaling may be employed). In contrast, the first and second sub-PU TMVP merge candidates 702 and 703 can be derived using two different sub-PU TMVP algorithms.

In addition, in alternative examples, positions of the two sub-PU TMVP merge candidates can be different from what is shown in FIG. 7. For example, the two sub-PU TMVP merge candidates 702-703 can be reordered to the front part of the merge candidate list 700 when it is determined that the current PU may have a higher possibility to be processed with sub-PU TMVP methods. In other words, when it is determined that the sub-PU TMVP merge candidates 702 or 703 may have a higher possibility to be selected among the merge candidates in the candidate list 700, the sub-PU TMVP merge candidates 702 or 703 can be moved towards the start of the merge candidate list 700. In this way, a merge index corresponding to a selected sub-PU TMVP merge candidate can be coded with a higher coding efficiency.

Examples of various sub-PU TMVP algorithms are described below. The process 600 in FIG. 6 example can be one choice of sub-PU TMVP algorithms, and can be referred to as an original sub-PU TMVP algorithm. The sub-PU TMVP algorithms described below can each include one or more steps or operations that are different from what is performed in the original sub-PU TMVP algorithms, where the same sub-PU TMVP algorithm may be considered as being applied to for the sub-PU TMVP algorithms including one or more steps or operations that are different from what is performed in the original sub-PU TMVP algorithms and/or the original sub-PU TMVP algorithms. Except those different steps and operations described below, other steps or operations in the sub-PU TMVP algorithms described below can be the same or different from what is performed in the original sub-PU TMVP algorithm. The purpose of employment of multiple different sub-PU algorithms are to provide multiple sub-PU TMVP merge candidates, and increase probabilities of selecting a better merge candidate for encoding a current PU.

### EXAMPLE I. 1

In the original sub-PU TMVP algorithm, as described at S610 in the process 600 in FIG. 6 example, a motion vector from a first available spatial neighboring block can be used as an initial motion vector (denoted as vec_init). In contrast, in this example I. 1, an initial motion vector (vec_init) can be generated by averaging several motion vectors instead of adopting the motion vector from the first available spatial neighboring block of a current PU. For example, the initial motion vector can be generated by averaging spatial neighboring motion vectors of a current PU, or by averaging several already-generated merge candidates, positions and/or orders of which are before that of a sub-PU TMVP candidate in a merge candidate list.

In a first case, motion vectors of spatial neighboring blocks of the current PU can be averaged to obtain an initial motion vector. In a first example, the spatial neighboring blocks can be a subset of blocks at the A0, A1, B0, B1, or B2 candidate positions as shown in FIG. 3. For example, the spatial neighboring blocks can be PUs overlapping the candidate positions, or can be sub-PUs overlapping the candidate positions. In a second example, the spatial neighboring blocks can be defined as neighboring blocks at positions A0′, A1′, B0′, B1′, or B2′. The positions A0′, A1′, B0′, B1′, or B2′ are defined in the following way. Position A0′ means the left-top corner sub-block (sub-PU) of a neighboring PU which contains the position A0, position A1′ means the left-top corner sub-block of the PU which containing A1, and so on. A subset of motion vectors from sub-blocks (sub-PUs) at positions {A0′, A1′, B0′, B1′, B2′ } can be averaged to obtain the initial motion vector. One example of position A1′ is shown in FIG. 8. As shown, a current PU 810 has a spatial neighboring PU 820 at position A1. A sub-block 821 at the top-left corner of the neighboring PU 820 is defined to be position A1′. Motion vector(s) of the sub-block 821 are to be averaged with other neighboring motion vectors. In a third example, the spatial neighboring blocks to be averaged can include sub-blocks at both positions A0, A1, B0, B1, B2 and positions A0′, A1′, B0′, B1′, B2′.

In a second case, a subset of motion vectors of merge candidates, positions and/or orders of which are before that of a sub-PU TMVP candidate being derived (referred to as a current sub-PU TMVP candidate) in a merge candidate list, can be averaged to obtain an initial merge candidate for deriving the current sub-PU TMVP candidate.

In some examples, for K candidates among all spatial neighboring blocks or K candidates among all merge candidates before the position or order of a current sub-PU TMVP candidate in the merge list, the motion vectors can be denoted as MV1_L0, MV1_L1, MV2_L0, MV2_L1, . . . , MVK_L0, MVK_L1, or denoted as MVi_L0, and MVi_L1, in which i=1 to K. MVi_L0 and MVi_L1 represent motion vectors associated with reference picture List 0 and list 1, respectively. Accordingly, MVi_L0 and MVi_L1 for i=1 to K can be averaged to get a final motion vector for the initial motion vector.

Several examples of averaging operations are described below. In one example, average for motion vectors associated with List 0 and List 1 is performed separately. Specifically, a subset of all the MVi_L0 can be averaged into one motion vector for List 0, referred to as MV_avg_L0. The MV_avg_L0 may not exist because MVi_L0 may not be available at all, or by other reasons. A subset of all the MVi_L1 can be averaged into one motion vector for List 1, referred to as MV_avg_L1. Similarly, the MV_avg_L1 may not exist because MVi_L1 may not be available at all or by other reasons. Then, the vec_init can be MV_avg_L0 or MV_avg_L1 depending on which of the List 0 or List 1 is preferred (selected), and depending on the availability of MV_avg_L0 and MV_avg_L1. For example, during the main collocated search process in FIG. 6 example, one of the List 0 or List 1 is selected to be a first to-be-searched list (referred to as a first list, a preferred list) according to some considerations.

In one example, all MVi_L0 and MVi_L1 (i=1˜K) are averaged into one motion vector. During the averaging, only motion vectors pointing to a same reference picture (named as a target picture for averaging) are picked for the averaging. For example, the target picture for averaging can be a chosen reference picture (such as a first picture in List 0 or List 1). Or, the target picture can be a picture associated with a motion vector of a first available neighboring block corresponding to a first to-be-searched list for searching a main collocated picture. The first available neighboring block can be at one of positions A0, A1, B0, B1, B2 or A0′, A1′, B0′, B1′, B2′ or a neighboring block of one of merge candidates before the current sub-PU TMVP candidate in a respective merge candidate list.

It is noted that although in the above examples, the initial vectors are obtained in a way different from the FIG. 6 example (a motion vector of a first available spatial neighboring block is adopted in FIG. 6 example), the possible motion vector scaling operations can still be performed for a later stage as described in the process 600. In other words, the motion vector scaling operation can still be performed during the collocated reference picture searching process after an initial vector is obtained by the above averaging methods.

### EXAMPLE I. 2

In the original sub-PU TMVP algorithm, a main collocated picture of a current PU can be obtained as a result of the collocated picture search process at S610 of the process 600. This main collocated picture can be denoted as main_colpic_original. In this example I. 2 of sub-PU TMVP algorithm, a main collocate picture (denoted as main_colpic) is determined to be a reference picture that is in an opposite direction (or so-called in an opposite list) from a current picture containing the current PU with respect to the main_colpic_original, and, for example, that has a picture order count (POC) distance to the current picture the same as a POC distance of the main_colpic_original to the current picture.

For example, the main_colpic_original can first be found using the collocated picture searching process at S610 in the process 600. Then, the main_colpic can be determined to be a reference picture within an opposite list that is a different list from the list of the main_colpic_original. In addition, the main_colpic can have, for example, a same POC distance to a current picture containing the current PU as that of the main_colpic_original. In other words, the new main_colpic is a reference picture with “list=opposite of list of main_colpic_original” and “POC distance=POC distance of main_colpic_original”. For example, if the decided collocated picture of searching by the searching process is List 0, and has a reference index 2, and, for example, this collocated reference picture and the current picture containing the current PU has a POC distance of 3, then the opposite list (in this example, is List 1) can be determined, and one reference picture with a POC distance of 3 in the List 1 can be determined to be the new collocated picture. When the new collocated picture is not available (for example, may fail from the “availability checking”), the algorithm of Example I. 2 results in no result. In one example, the original main collocated picture can be kept, resulting main_colpic=main_colpic_original.

### EXAMPLE I. 3

In the original sub-PU TMVP algorithm, as described at S610 in the process 600 in FIG. 6 example, a motion vector from a first available spatial neighboring block can be used as an initial motion vector (denoted as vec_init). In addition, the first available spatial neighboring block may have two motion vectors associated with two reference pictures lists, List 0 and List 1. The selected motion vector used as vect init is the one associated with a first reference picture list. The first list is one of the List 0 and List 1 that is first searched during the collocated picture search process at S610 of the process 600. The other one of the List 0 and List 1 that is searched afterwards is referred to as a second list. Whether List 0 or List 1 is used as a first list can be determined according to a rule, or can be predefined.

In contrast, in this example I. 3 of sub-PU TMVP algorithm, an initial motion vector is selected to be a motion vector that is different from a motion vector of a first available spatial or temporal neighboring block associated with a first list as adopted in the original sub-PU TMVP algorithm. In one example, an initial motion vector can be selected from a motion vector of a second available spatial or temporal neighboring block, or a motion vector of a first available spatial neighboring block but associated with a second list of the first available spatial neighboring block in example I.3 algorithm. The selection can depend on availability of the second available spatial neighboring block and the second list of the first available spatial neighboring block. In one example, candidates for an initial vector can be some spatial or temporal neighboring motion vectors, or some merge candidates (either special or temporal neighboring candidates) before a current sub-PU TMVP candidate in a merge candidate list. Accordingly, multiple different initial motion vectors can be determined to derived multiple sub-PU candidates using the algorithm of Example I. 2.

The candidates for the initial vector can be denoted as cand_mv_0, cand_mv_1, . . . , and cand_mv_m, or denoted as cand_mv_i (i is 1 to m). Each cand_mv_{—i} may have a List 0 motion vector, and a List 1 motion vector. In the original sub-PU TMVP algorithm, a motion vector associated with the first list (if the first list doesn't exist, then chooses a second list) of the first neighbor is selected to be the initial vector.

In a sub-PU TMVP algorithm of the type of Example I.3, in one example, a motion vector associated with a second neighboring block or a second list of the first neighbor block is selected to be the initial vector depending on availability of cand_mv_i or availability of lists inside cand_mv_i. For example, when the availability of every cand_mv_i or availability of lists inside cand_mv_i meets a certain condition (named condition 1), it chooses the second neighbor, or, when the availability of every cand_mv_i or availability of lists inside cand_mv_i meets another condition (named condition 2), it chooses the second list of the first neighbor. When the availability of every cand_mv_i or availability of lists inside cand_mv_i meets a third certain condition (named condition 3), it stops the current Sub-PU TMVP process (current Sub-PU TMVP is not available in this case).

It is noted that, although an initial vector is generated in the above Example I. 3 algorithm in a way different from the original sub-PU TMVP algorithm, the possible motion vector scaling operation may still be needed for the later stage (the collocated picture search process) as described in the process 600 in FIG. 6 example.

Several examples for selecting an initial motion vector from a second available spatial neighboring block or selecting an initial motion vector from a first available spatial neighboring block associated with a second list are described below.

### EXAMPLE I. 3-1

In this example, when cand_mv_i is available only when i=0, and not available for i>=1, then condition 3 is met and it stops current sub-PU TMVP process (current sub-PU TMVP is not available in this case). When cand_mv_i exists when i=0 and 1, then condition 1 is met. The second neighboring block can be selected to provide the initial vector.

In other words, when only a first spatial neighboring block is available, the current sub-PU TMVP algorithm terminates, and no sub-PU TMVP merge candidate is resulted from the current sub-PU TMVP algorithm. When a second spatial neighboring block is available, a motion vector of the second spatial neighboring block is selected to be an initial motion vector.

### EXAMPLE I. 3-2

In this example, when cand_mv_i is available only when i=0, and not available for i>=1, and only List 0 motion vector or only List 1 motion vector is available in cand_mv_0 (that is, not both List 0 and List 1 exist), then condition 3 is met and it stops current sub-PU TMVP process (current sub-PU TMVP is not available in this case). When cand_mv_i is available only when i=0, and not available for i>=1, and both List 0 and List 1 motion vector are available in cand_mv_0, then condition 2 is met and it chooses a motion vector associated with the second list of the first available neighbor. When cand_mv_i exists when i=0 and 1, then condition 1 is met. A motion vector of the second neighbor can be selected to be the initial motion vector.

### EXAMPLE I. 3-3

In this example, when cand_mv_i is available only when i=0, and not available for i>=1, and only List 0 motion vector or only List 1 motion vector is available in cand_mv_0 (that is, not both List 0 and List 1 exist), then condition 3 is met and it stops current sub-PU TMVP process (current sub-PU TMVP is not available in this case). When cand_mv_i is available only when i=0, and not available for i>=1, and both List 0 and List 1 motion vector are available in cand_mv_0, then condition 2 is met and it chooses a motion vector associated with the second list of the first neighbor. When cand_mv_i exists when i=0 and 1, and both List 0 and List 1 motion vector are available in cand_mv_0, then condition 2 is met and it chooses a motion vector of the second list of the first neighbor. When cand_mv_i exists when i=0 and 1, and not both List 0 and List 1 motion vector are available in cand_mv_0, then condition 1 is met. A motion vector of the second neighbor can be selected. In this example, the condition 2 has two related cases.

### EXAMPLE I. 4

In this example of sub-PU TMVP algorithm, temporal collocated motion vectors of sub-PUs of a current PU can first be obtained, and then the temporal collocated motion vectors of sub-PUs are mixed with motion vectors of spatial neighboring sub-PUs, thus resulting in mixed motion vectors of sub-PUs of the current PU. The temporal collocated motion vectors of sub-PUs can be obtained by any suitable sub-PU TMVP algorithms, such as the sub-PU TMVP algorithms described in this disclosure.

For example, in a process performing a sub-PU TMVP algorithm of the type of Example I.4, the collocated sub-PU motion vectors can first be obtained by the algorithms of Examples I-III previously described. Then, top neighboring block motion vectors (outside the current PU) and motion vectors of sub-blocks (sub-PUs) near the top edge of the current PU (inside current PU) can be averaged, and the resulting averages can be filled into original sub-blocks near the top edge of the current PU. In addition, left neighboring block motion vectors (outside current PU) and motion vectors of sub-blocks near the left edge of the current PU (inside current PU) can be averaged, and the resulting averages can be filled into original sub-blocks near the left edge of the current PU. For the sub-blocks near top and left edge of the current PU, top and left neighboring block motion vectors (outside current PU) and motion vectors of sub-blocks near top and left edge of the current PU (inside current PU) can be averaged and the resulting averages can be filled into the original sub-blocks near top and left edge of the current PU.

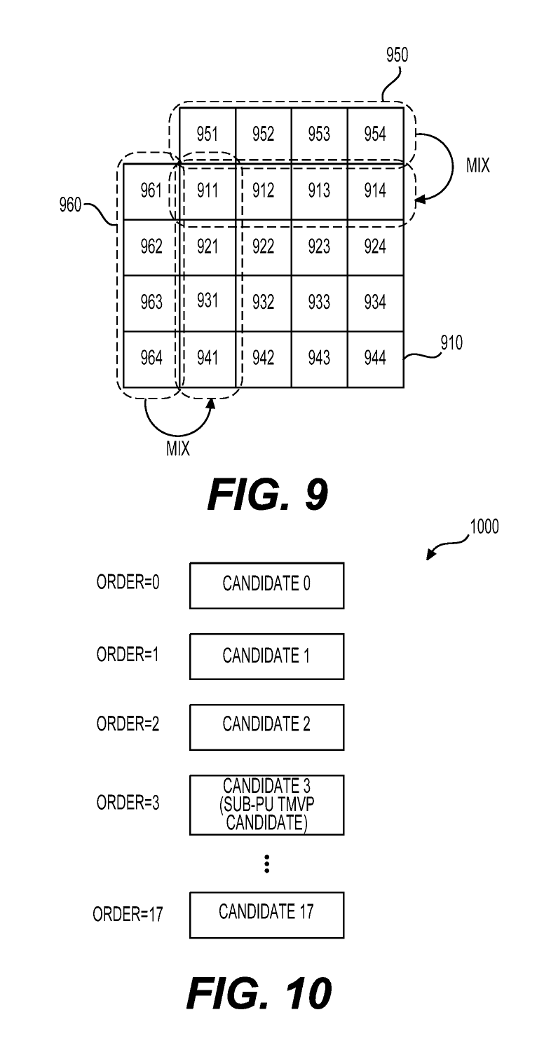

FIG. 9 shows an example of mixing motion vectors of sub-PUs of a current PU 910 with motion vectors of spatial neighboring sub-PUs according to an embodiment of the disclosure. As shown, the current PU 910 can include a set of sub-PUs 911-914, 921-924, 931-934, and 941-944. Motion information of each sub-PU of the current PU 910 can be obtained firstly using a sub-PU TMVP algorithm. A first set 950 of spatial neighboring sub-PUs 951-954 can be located on the top of the current PU 910, and a second set 960 of spatial neighboring sub-PUs 961-964 can be located on the left of the current PU 910. In one example, each of the sub-PUs 951-954, and 961-964 can have motion information derived by performing a sub-PU TMVP algorithm.

Motion vectors of sub-PUs of the current PU 910 can be mixed with that of spatial neighboring sub-PUs. For example, motion vectors of the top neighboring sub-PU 952 and the top row sub-PU 912 can be averaged, and the resulting average can be used as a motion vector of the top row sub-PU 912. Similarly, motion vectors of the left neighboring sub-PU 962 and the left-most column sub-PU 921 can be averaged, and the resulting average can be used as a motion vector of the left-most column sub-PU 921. In addition, motion vectors of sub-PUs 951, 911, and 961 can be averaged, and the resulting average can be used as a motion vector of the sub-PU 911.

In alternative examples, methods for mixing the motion vectors of the current PU 910 with spatial neighboring motion vectors can be different from the method described above. For example, in one example, a motion vector of the sub-PU 923 is averaged with that of the top neighboring sub-PU 953 (a top neighboring sub-PU at the same column as the sub-PU 923), and that of the left neighboring sub-PU 962 (a left neighboring sub-PU at the same row as the sub-PU 923). Other sub-PUs of the current PU 910 can be processed in a similar way.

Examples of the multiple sub-PU TMVP merge candidates method are described below. In those examples, multiple sub-PU TMVP algorithms described herein are utilized to derive multiple merge candidates.

Example 1: there are 2 sub-PU TMVP candidates in the candidate list. The first candidate is derived by the original sub-PU TMVP algorithm, and the second sub-PU TMVP candidate uses a sub-PU TMVP algorithm of the type of Example I. 1.

Example 2: there are 2 sub-PU TMVP candidates in the candidate list. The first candidate is derived by the original sub-PU TMVP algorithm, and the second sub-PU TMVP candidate uses a sub-PU TMVP algorithm of the type of Example I. 3.

Example 3: there are 2 sub-PU TMVP candidates in the candidate list. The first candidate is derived by the original sub-PU TMVP algorithm, and the second sub-PU TMVP candidate uses a sub-PU TMVP algorithm of the type of Example I. 4.

Example 4: there are 2 sub-PU TMVP candidates in the candidate list. The two sub-PU TMVP candidates use two different algorithms of the Examples I. 1-4.

In some examples, one algorithm can be employed to derive more than one sub-PU TMVP candidates. For example, a candidate list can include 4 sub-PU TMVP candidates. Among the 4 sub-PU TMVP candidates, three sub-PU TMVP candidates can be derived using the algorithm of Example 1.3. For example, three different initial motion vectors can be selected to be (A) a motion vector of a second available neighboring block, (B) a motion vector of a first available neighboring block associated with a second reference picture list, and (C) a motion vector of a third available neighboring block. The other one of the 4 sub-PU TMVP candidates can be derived using the algorithm of Example 1.2. For another example, three sub-PU TMVP candidates can be derived using the algorithm of the Example 1.3. Four sub-PU TMVP candidates can be derived using the algorithm of the example 1.2. As a result, a resulting merge candidate list can include seven sub-PU TMVP candidates.

Of course, in alternative example, more than two sub-PU TMVP algorithms can be utilized to derived more than two sub-PU TMVP merge candidates for a merge candidate list. In addition, in some examples, when multiple sub-PU TMVP algorithms are employed, it is possible that some of the sub-PU TMVP algorithms may not result in an available merge candidate. For example, when three sub-PU TMVP algorithms are employed, zero, one, two, three, or more than three merge candidates can be obtained.

Further, in some examples, based on signaling between an encoder and a decoder, or based on a pre-configuration (e.g., as specified in a video coding standard), the encoder and decoder can employ a same number of sub-PU TMVP algorithms and a same set of multiple types of sub-PU TMVP algorithms to conduct sub-PU TMVP mode operations to process PUs. Accordingly, a same set of sub-PU TMVP merge candidates can be generated at the encoder side and the decoder side.

II. On-Off Switching Control of Sub-PU TMVP Merge Candidates

Based on the above described multiple sub-PU TMVP candidates method, an on-off switching control mechanism is utilized in some examples to determine whether a certain sub-PU TMVP candidate is used as a member of a final merge candidate list. The idea behind the on-off switching control scheme is to turn on or turn off a certain sub-PU TMVP candidate depending on number of candidates in the candidate list, or depending on a similarity between several sub-PU TMVP candidates, or depending on other factors. The certain sub-PU TMVP candidate under evaluation is referred to as a current sub_PU TMVP candidate.

For example, two sub-PU TMVP candidates may be similar to each other, and including both will not result in significant coding gain. Or, a current PU has a smaller size that is closer to a sub-PU size if this PU is partitioned into sub-PUs. In this scenario, operations of sub-PU TMVP mode is not necessary because cost of a sub-PU TMVP operation may be higher than coding gains obtained. In further examples, there may be too many merge candidates, which leads to heavy computational cost not worth the respective coding gains. Based on the above or other considerations, certain sub-PU TMVP candidates can be switched off and not included in a final merge candidate list.

FIG. 10 shows an example of the sub-PU TMVP candidate on-off switching control mechanism according to an embodiment of the disclosure. FIG. 10 shows a sequence 1000 of merge candidates from candidate 0 to candidate 17 each corresponding to a candidate order. Each candidate order can indicate a position of a respective candidate in the sequence 1000. The sequence 1000 can be a predefined sequence. The sequence 1000 can include members that are of sub-PU TMVP candidate type, and are derived or to-be derived by sub-PU TMVP algorithms (such as the sub-PU TMVP algorithm examples described herein), while the sequence 1000 can also include other members that are not sub-PU TMVP candidates (for example, those members can be merge information of spatial and/or temporal neighboring blocks of a current PU).

In one example, the candidate 3 is a sub-PU TMVP candidate in the sequence 1000. Based on the on-off switching control mechanism, a decision can be made to turn off the candidate 3. In other words, the candidate 3 will not be included in a final merge candidate list. In some scenarios, the decision can be made before the candidate 3 is derived, thus deriving of the candidate 3 can be skipped. In other scenarios, the decision can be made after the candidate 3 has been derived. The sequence 700 can be referred to as a being-constructed merge candidate list with respect to the final merge candidate list.

Some examples of implementing the on-off switching control mechanism are described below.

### EXAMPLE II. 1

In this example, for a certain sub-PU TMVP candidate in a candidate list (such as the sequence 1000), if the number of candidates (which are before this sub-PU TMVP candidate in the candidate list and are not of sub-PU TMVP type) exceeds a threshold, then this sub-PU TMVP candidate is turned off (not included in a final candidate list). In some examples, after the turning off decision is made, operations of deriving this sub-PU TMVP candidate can be skipped. In some examples, the turning off decision is made after this sub-PU TMVP candidate is derived.

For example, as shown in FIG. 10, the candidate order of a certain sub-PU TMVP candidate can be denoted as cur_order. The number of candidates that each have a candidate order less than the cur_order and are not of sub-PU TMVP type can be denoted as num_cand_before. If num_cand_before>the threshold, then this sub-PU TMVP candidate is turned off. In the final candidate list, no merge index is assigned to sub-PU TMVP candidates that are turned off.

### EXAMPLE II. 2

In this example, for a certain sub-PU TMVP candidate in the candidate list (such as the sequence 1000), if the number of candidates (which are before this sub-PU TMVP candidate in the candidate list) exceeds a threshold, then this sub-PU TMVP candidate is turned off. For example, the candidate order of a certain Sub-PU TMVP candidate can be denoted as cur_order. The number of candidates having candidate order less than cur_order can be denoted as num_cand_before. If num_cand_before>the threshold, then this sub-PU TMVP candidate is turned off. In some examples, after the turning off decision is made, operations of deriving this sub-PU TMVP candidate can be skipped. In some examples, the turning off decision is made after this sub-PU TMVP candidate is derived.

### EXAMPLE II. 3

In this example, two sub-PU TMVP candidates in a candidate list (such as the sequence 1000) can be compared. When a difference of the two sub-PU TMVP candidates is lower than a threshold, one of the two sub-PU TMVP candidates is turned off and not included in a final merge candidate list.

For example, for a first sub-PU TMVP candidate (denoted as sub_cand_a) in a candidate list (such as the sequence 1000), a second sub-PU TMVP candidate in the same candidate list (denoted as sub_cand_b) can be selected to compare with the first sub-PU TMVP candidate. As a result, a difference between sub_cand_a and sub_cand_b can be determined. If the difference between sub_cand_a and sub_cand_b is lower than a threshold, then this sub-PU TMVP candidate (sub_cand_a) is turned off.

Examples of computing the difference of two sub-PU TMVP merge candidates are described below.

### EXAMPLE II. 3-1

In this example, the difference is calculated by determining a motion vector difference between an initial vector of sub_cand_a (the initial vector used in a sub-PU TMVP algorithm for deriving the sub_cand_a) and an initial vector of sub_cand_b. In one example, the motion vector difference can be calculated as abs(MV_x_a−MV_x_b)+abs(MV_y_a−MV_y_b), where abs( ) represents an absolute operation, MV_x_a, or MV_x_b represents an horizontal displacement of the initial vector of sub_cand_a or sub_cand_b, respectively. MV_y_a, or MV_y_b represents a vertical displacement of the initial vector of sub_cand_a or sub_cand_b, respectively. In other examples, the motion vector difference may be calculated in a way different from the above example.

### EXAMPLE II. 3-2

In this example, the difference is calculated by averaging all motion vector differences between corresponding sub-PUs of sub_cand_a and sub_cand_b. For example, if there are (M/P)×(N/Q) sub-PUs (where M is divisible by P, and N is divisible by Q) in a current PU of a size of M×N pixels. Each sub-PU has a size of P×Q pixels. Each sub-PU can be denoted as sub(i, j), where i means a horizontal index and i=1 to (M/P), and j means a vertical index and j=1 to (N/Q). The example can be described by the following pseudo code,

accumulated_mv_diff = 0;
for(all sub(i, j))
{
mv_diff = difference between (MV of sub(i, j) of sub_cand_a) and

(MV of sub(i, j) of sub_cand_b);

accumulated_mv_diff = accumulated_mv_diff + mv_diff;
}
averaged_accumulated_mv_diff = accumulated_mv_diff / (total
number of sub-PUs);
difference = averaged_accumulated_mv_diff.

### EXAMPLE II. 4

In this example, the on-off switching control for a certain sub-PU TMVP candidate depends on a size of a current PU area. The PU area can be defined as “the PU width×the PU height”. If the current PU size is smaller than a threshold, then this sub-PU TMVP candidate is turned off.

### EXAMPLE II. 5

In this example, the on-off switching control for a certain sub-PU TMVP candidate depends on a size of a current PU area. The PU area can be defined as the PU width×the PU height. If the current PU size is larger than a threshold, then this sub-PU TMVP candidate is turned off

### EXAMPLE II. 6

In this example, the on-off switching control performed with a consideration of a combination of multiple factors, such as current PU size, merge candidate number, sub-PU TMVP motion vector similarity, and the like. For example, the current PU size can first be considered, then merge candidate number can be considered. As a result, certain sub-PU TMVP candidates can be turned off and not included in a final merge list, and associated deriving operations can be avoided. Subsequently, the sub-PU TMVP motion vector similarity can be considered. In different embodiments, orders for combination of different factors can be different, and the number of factors to be considered can also be different.

Additionally, the sub-PU TMVP on-off switching control mechanism is adjustable in various examples (e.g., Examples II. 1-6). In one example, a flag can be signaled from a video encoder to a video decoder to indicate whether to switch on or off the sub-PU TMVP on-off switching control mechanism. For example, a flag of 0 can indicate the sub-PU TMVP on-off switching control mechanism is not performed (switched off). The flag indicating whether to switch on or off the sub-PU TMVP on-off switching control mechanism can be coded or signaled in sequence level, picture level, slice level, or PU level.

In one example, a flag can be signaled from a video encoder to a video decoder to indicate whether to switch on or off a specific method of the sub-PU TMVP on-off switching control mechanism. For example, the specific method can be a method described in one of the above examples II. 1-6. Similarly, the flag indicating whether to switch on or off a specific method can be coded or signaled in sequence level, picture level, slice level, or PU level.

In one example, a threshold value, such as a value of a candidate number threshold in Example II. 1-2, a sub-PU TMVP motion vector difference (or similarity) threshold in Examples II. 3, a current PU size threshold in Example II. 4-5, and the like, can be adjustable. In addition, a threshold value can be signaled from an encoder , for example, in sequence level, picture level, slice level, or PU level.

III. Context Based Sub-PU TMVP Merge Candidate Reordering

In some embodiments, a context based sub-PU TMVP merge candidate reordering method can be employed. For example, positions of sub-PU TMVP merge candidates in a candidate list of a current PU can be reordered according to coding modes of neighboring blocks of the current PU. For example, if most of the neighboring blocks, or a number of the neighboring blocks above a percentage, are coded with sub-PU modes (such as the sub-PU TMVP mode), the current PU may have a higher probability to be coded with the sub-PU TMVP mode. In other words, a current sub-PU TMVP merge candidate of the current PU may have a higher chance of being selected among other candidates (e.g., candidates from spatial neighboring blocks which can be referred to as non-sub-PU candidates) in the candidate list as a result of a rate-distortion evaluation process.

Accordingly, the current sub-PU TMVP merge candidate can be reordered from a current position (a predefined position, or an original position) to a reordered position towards the front part of the merge candidate list. For example, the current sub-PU TMVP candidate can be moved to a position in front of the original position, or to a position at the front part of the merge candidate list. As a result, a merge index with a smaller value can be assigned to this reordered current sub-PU TMVP merge candidate compared with remaining at the previous position. As the current sub-PU TMVP candidate has a higher chance of being selected and has been assigned a smaller merge index (that leads to a higher coding efficiency), the reordering operation can provide a coding gain for processing the current PU.

The current position of the current PU before the reordering in the above example can be a position in a predefined candidate list. For example, averagely, a merge candidate resulting from a sub-PU mode may have a lower chance of being selected among other non-sub-PU mode merge candidates in a candidate list in some examples, thus in the predefined candidate list, a sub-PU TMVP candidate may be positioned at the rear part of the candidate list, for example, after some spatial merge candidates. This arrangement can benefit average situations of coding PUs. When it is detected that, a current sub-PU may have a higher chance of being coded with a sub-PU mode (a sub-PU merge candidate may have a higher chance of being selected from the merge list), the reordering operating can accordingly be carried out to potentially obtain a higher coding gain.

When considering a context for the candidate position reordering, multiple sub-PU modes can be taken into account. In addition to the sub-PU TMVP mode, the sub-PU modes can include affine mode, spatial-temporal motion vector prediction (STMVP) mode, frame rate up conversion (FRUC) mode, and the like. In those sub-PU modes, a current PU can be partitioned into sub-PUs and motion information of those sub-PU can be obtained and manipulated. For example, an example of affine mode is described in the work of Sixin Lin, et al., “Affine transform prediction for next generation video coding”, ITU—Telecommunications Standardization Sector, STUDY GROUP 16 Question Q6/16, Contribution 1016, September 2015, Geneva, CH. An example of STMVP mode is described in the work of Wei-Jung Chien, et al., “Sub-block motion derivation for merge mode in HEVC”, Proc. SPIE 9971, Applications of Digital Image Processing XXXIX, 99711K (27 September 2016). An example of FRUC mode is described in the work of Xiang. Li, et al., “Frame rate up-conversion based motion vector derivation for hybrid video coding”, 2017 Data Compression Conference (DCC).

In one example, depending on the coding mode(s) of top neighboring blocks (outside a current PU) and left neighboring blocks (outside the current PU), a sub-PU TMVP candidate of the current PU may be reordered to the front part in a respective candidate list, or to a position in front of the original position. For example, the mode(s) of the top neighboring blocks and left neighboring blocks can be sub-PU modes (such as an affine mode, a sub-PU TMVP mode, or other sub-PU based mode), or a normal mode (non-sub-PU mode). When motion information of a neighboring block of the current PU is obtained from a sub-PU mode process, such as a sub-PU TMVP mode process where a sub-PU TMVP mode algorithm is performed, the neighboring block is said to be coded with the respective sub-PU mode, and a coding mode of this neighboring block is said to be a sub-PU mode. In contrast, if motion information of a neighboring block of the current PU is obtained from a non-sub-PU mode, such as a conventional merge mode or an intra prediction mode, a mode of this neighboring block is said to be a non-sub-PU mode.

Assuming there are a total of p number of coding modes (e.g., intra mode, traditional merge mode, sub-PU modes, and the like) in a video codec, and there are q number of modes which are to-be-considered sub-PU based modes (e.g., affine mode, sub-PU TMVP candidate mode, or other modes), a context computation can be conducted in the following way. First, the to-be-considered q number of sub-PU modes can be denoted as ctx_mode. The ctx_mode can include one or multiple sub-PU modes. In one example, the ctx_mode may be affine mode, and sub-PU TMVP mode. In another example, the ctx_mode may be sub-PU TMVP mode only. In a further example, the ctx_mode may be all sub-PU based modes. The possible modes included in the ctx_mode are not limited to these examples.

Accordingly, the context based candidate reordering method can firstly count the number of top neighboring sub-blocks and left neighboring sub-blocks of the current PU that have a mode belonging to the ctx_mode. In one example, each neighboring sub-block under consideration is a minimum coding unit, such as a size of 4×4 pixels. The counting result is denoted as cnt_0. Then, if the value of cnt_0/(total number of top neighboring sub-blocks and left neighboring sub-blocks) is higher than a pre-defined threshold, then the sub-PU TMVP candidate can be reordered, for example, to the front part of candidate list, or to a position in front of the original position. In other words, when a percentage of top and left neighboring sub-blocks having motion information derived in a sub-PU mode(s) among top and left neighboring sub-blocks is above a threshold, the sub-PU TMVP merge candidate at the original position in the merge candidate list can be reordered to a position in front of the original position, or to a position at the front part of the merge candidate list.

In one example, the orders (positions) of sub-PU TMVP candidates are exchanged with the orders (positions) of normal non-sub-PU candidates (not obtained from a sub-PU TMVP algorithm) in the candidate list. For example, if the candidate list has q1 normal candidates, each with a candidate order normal cand_order_i (i is 1˜q1), and q2 sub-PU TMVP candidates, each with a candidate order subtmvp_cand_order_i (i is 1˜q2). In addition, normal_cand_order_a<normal_cand_order_b if a<b, and subtmvp_cand_order_c<subtmvp_cand_order_d if c<d. The candidate orders of all these q1+q2 candidates can be further decoded as nor_sub_order_i (i is 1˜(q1+q2)), and nor_sub_order_e<nor sub_order_f if e<f.

Then, if the value of cnt_0/(total number of top neighboring subblocks and left neighboring subblocks) is higher than a pre-defined threshold, the candidate lists can be reordered in the following way,

subtmvp_cand_order_j=nor_sub_order_j (j=1 to q2), and

normal_cand_order_j=nor_sub_order_k (k=(q2+1) to (q1+q2)).

In other words, the sub-PU TMVP candidates are arranged in front of the normal candidates in the merge candidate list.

The processes and functions described herein can be implemented as a computer program which, when executed by one or more processors, can cause the one or more processors to perform the respective processes and functions. The computer program may be stored or distributed on a suitable medium, such as an optical storage medium or a solid-state medium supplied together with, or as part of, other hardware. The computer program may also be distributed in other forms, such as via the Internet or other wired or wireless telecommunication systems. For example, the computer program can be obtained and loaded into an apparatus, including obtaining the computer program through physical medium or distributed system, including, for example, from a server connected to the Internet.

The computer program may be accessible from a computer-readable medium providing program instructions for use by or in connection with a computer or any instruction execution system. The computer readable medium may include any apparatus that stores, communicates, propagates, or transports the computer program for use by or in connection with an instruction execution system, apparatus, or device. The computer-readable medium can be magnetic, optical, electronic, electromagnetic, infrared, or semiconductor system (or apparatus or device) or a propagation medium. The computer-readable medium may include a computer-readable non-transitory storage medium such as a semiconductor or solid state memory, magnetic tape, a removable computer diskette, a random access memory (RAM), a read-only memory (ROM), a magnetic disk and an optical disk, and the like. The computer-readable non-transitory storage medium can include all types of computer readable medium, including magnetic storage medium, optical storage medium, flash medium, and solid state storage medium.

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

What is claimed is:

1. A video coding method for processing a current prediction unit (PU) with sub-PU temporal motion vector prediction (TMVP) mode, comprising:
performing sub-PU TMVP algorithms to derive sub-PU TMVP candidates, each of the derived sub-PU TMVP candidates including sub-PU motion information of sub-PUs of the current PU; and
including none or a subset of the derived sub-PU TMVP candidates into a merge candidate list of the current PU.

2. The video coding method of claim 1, wherein performing sub-PU TMVP algorithms to derive sub-PU TMVP candidates includes:
performing sub-PU TMVP algorithms to derive zero, one or more sub-PU TMVP candidates.

3. The video coding method of claim 1, wherein more than one sub-PU TMVP candidates are derived from a same one of the sub-PU TMVP algorithms.

4. The video coding method of claim 1, further comprising:
providing at least two sub-PU TMVP algorithms,
wherein the performed sub-PU TMVP algorithms are a subset of the provided at least two sub-PU TMVP algorithms.

5. The video coding method of claim 4, wherein the provided at least two sub-PU TMVP algorithms includes one of:
a first sub-PU TMVP algorithm, wherein an initial motion vector is a motion vector of a first available spatial neighboring block of the current PU;
a second sub-PU TMVP algorithm, wherein an initial motion vector is obtained by averaging motion vectors of spatial neighboring blocks of the current PU, or by averaging motion vectors of merge candidates before a sub-PU TMVP candidate being derived in the merge candidate list;
a third sub-PU TMVP algorithm, wherein a main collocated picture is determined to be a reference picture that is different from an original main collocated picture being found during a collocated picture search process;
a fourth sub-PU TMVP algorithm, wherein an initial motion vector is selected from a motion vector of a second available neighboring block of the current PU, or a motion vector of a first available neighboring block that is associated with a second list of the first available neighboring block, or motion vectors other than that of a first available neighboring block; or
a fifth sub-PU algorithm, wherein temporal collocated motion vectors of the sub-PUs of the current PU are averaged with motion vectors of spatial neighboring sub-PUs of the current PU.

6. The video coding method of claim 5, wherein in the second sub-PU TMVP algorithm, the spatial neighboring blocks of the current PU are one of:
a subset of blocks or sub-blocks at A0, A1, B0, B1, or B2 candidate positions specified in high efficiency video coding (HEVC) standards for merge mode;
a subset of sub-blocks at positions A0′, A1′, B0′, B1′, or B2′, wherein the positions A0′, A1′, B0′, B1′, or B2′ each correspond to a left-top corner sub-block of a spatial neighboring PU of the current PU which contains the position A0, A1, B0, B1, or B2, respectively; or a subset of sub-blocks at A0, A1, B0, B1, B2, A0′, A1′, B0′, B1′, or B2′ positions.

7. The video coding method of claim 5, wherein in the third sub-PU TMVP algorithm, the main collocated picture is determined to be a reference picture that is in an opposite list from a current picture containing the current PU with respect to the original main collocated picture.

8. The video coding method of claim 5, wherein in the fourth sub-PU TMVP algorithm, selecting the initial motion vector includes one of:
a first process, wherein,
when the first spatial neighboring block is available and other spatial neighboring blocks are not available, the current fourth sub-PU TMVP algorithm terminates, and
when the second spatial neighboring block is available, a motion vector of the second spatial neighboring block is selected to be the initial motion vector;
a second process, wherein,
when the first spatial neighboring block is available and other spatial neighboring blocks are not available, and only one motion vector of the first spatial neighboring block is available, the current fourth sub-PU TMVP algorithm terminates,
when the first spatial neighboring block is available and other spatial neighboring blocks are not available, and two motion vectors of the first spatial neighboring block associated with reference lists List 0 and List 1, respectively, are available, one of the two motion vectors associated with a second list of the first spatial neighboring block is selected to be the initial motion vector, and
when the second spatial neighboring block is available, a motion vector of the second spatial neighboring block is selected to be the initial motion vector; or
a third process, wherein,
when the first spatial neighboring block is available and other spatial neighboring blocks are not available, and only one motion vector of the first spatial neighboring block is available, the current fourth sub-PU TMVP algorithm terminates,
when a first spatial neighboring block is available and other spatial neighboring blocks are not available, and two motion vectors of the first spatial neighboring block associated with reference lists List 0 and List 1, respectively, are available, one of the two motion vectors associated with a second list of the first spatial neighboring block is selected to be the initial motion vector,
when the first and second spatial neighboring blocks are available, and two motion vectors of the first spatial neighboring block associated with reference lists List 0 and List 1, respectively, are available, one of the two motion vectors associated with a second list of the first spatial neighboring block is selected to be the initial motion vector, and
when the first and second spatial neighboring blocks are available, and only one motion vector of the first spatial neighboring block is available, a motion vector of the second spatial neighboring block is selected to be the initial motion vector.

9. The video coding method of claim 5, wherein the fifth sub-PU TMVP algorithm includes:
obtaining collocated motion vectors for the sub-PUs of the current PU;
averaging a motion vector of a top neighboring sub-PU of the current PU and a motion vector of a top row sub-PU of the current PU; and
averaging a motion vector of a left neighboring sub-PU of the current PU and a motion vector of a left-most column sub-PU of the current PU.

10. The video coding method of claim 1, further comprising:
determining whether to include a current sub-PU TMVP candidate in a being-constructed merge candidate list into the merge candidate list of the current PU, the current sub-PU TMVP candidate being to-be-derived with a respective sub-PU TMVP algorithm, or being one of the derived sub-PU TMVP candidates.

11. The video coding method of claim 10, further comprising:
determining whether to include the current sub-PU TMVP candidate in the being-constructed merge candidate list into the merge candidate list of the current PU based on at least one of,
a number of derived merge candidates before the current sub-PU TMVP candidate in the being-constructed candidate list;
a similarity between the current sub-PU TMVP candidate and another one of the derived sub-PU TMVP candidates in the being-constructed merge candidate list; or
a size of the current PU.

12. The video coding method of claim 10, wherein determining whether to include the current sub-PU TMVP candidate in the being-constructed merge candidate list into the merge candidate list of the current PU includes one of:
(a) when a number of derived merge candidates that are before the current sub-PU TMVP candidate in the being-constructed candidate list and are not of sub-PU TMVP type exceeds a threshold, excluding the current sub-PU TMVP candidate from the merge candidate list of the current PU;
(b) when a number of derived merge candidates that are before the current sub-PU TMVP candidate in the being-constructed candidate list exceeds a threshold, excluding the current sub-PU TMVP candidate from the merge candidate list of the current PU;
(c) when a difference of the current sub-PU TMVP candidate and another one of the derived sub-PU TMVP candidates in the being-constructed merge candidate list is lower than a threshold, excluding the current sub-PU TMVP candidate from the merge candidate list of the current PU;
(d) when a size of the current PU is smaller than a threshold, excluding the current sub-PU TMVP candidate from the merge candidate list of the current PU;
(e) when a size of the current PU is larger than a threshold, excluding the current sub-PU TMVP candidate from the merge candidate list of the current PU; or
(f) determining whether to include the current sub-PU TMVP candidate in the merge candidate list according to a combination of two or more conditions considered in (a)-(e).

13. The video coding method of claim 12, further comprising:
when the current sub-PU TMVP candidate is determined to be excluded from the merge candidate list of the current PU, skipping performing the respective sub-PU TMVP algorithm to derive the current sub-PU TMVP candidate.

14. The video coding method of claim 12, further comprising:
signaling a flag indicating whether to switch on or off operations of one or more of (a)-(f) from an encoder to a decoder.

15. The video coding method of claim 12, further comprising:
signaling a threshold value of one or more thresholds of (a)-(e) from an encoder to a decoder.

16. The video coding method of claim 10, further comprising:
signaling from an encoder to a decoder a flag indicating whether to switch on or off a sub-PU TMVP on-off switching control mechanism for determining whether to include a current sub-PU TMVP candidate in the being-constructed merge candidate list into the merge candidate list of the current PU.

17. The method of claim 1, further comprising:
reordering a sub-PU TMVP merge candidate in a being-constructed merge candidate list or the merge candidate list of the current PU towards the front part of the being-constructed merge candidate list or the merge candidate list of the current PU.

18. The method of claim 17, further comprising:
when a percentage of top and left neighboring sub-blocks of the current PU that have motion information derived with a sub-PU mode(s) is above a threshold, reordering the sub-PU TMVP merge candidate at an original position in the being-constructed merge candidate list or the merge candidate list of the current PU to a position in front of the original position, or to a position at the front part of the being-constructed merge candidate list or the merge candidate list of the current PU.

19. The method of claim 18, wherein the sub-PU mode(s) includes one or more of:
an affine mode, a sub-PU TMVP mode, a spatial-temporal motion vector prediction (STMVP) mode, and a frame rate up conversion (FRUC) mode.

20. A video coding apparatus for processing a current prediction unit (PU) with sub-PU temporal motion vector prediction (TMVP) mode, the apparatus comprising circuitry configured to:
perform sub-PU TMVP algorithms to derive sub-PU TMVP candidates, each of the derived sub-PU TMVP candidates including sub-PU motion information of sub-PUs of the current PU; and
include none or a subset of the derived sub-PU TMVP candidates into a merge candidate list of the current PU.

21. A non-transitory computer readable medium storing instructions which, when executed by a processor, cause the processor to perform a method for processing a current prediction unit (PU) with sub-PU temporal motion vector prediction (TMVP) mode, the method comprising:
performing sub-PU TMVP algorithms to derive sub-PU TMVP candidates, each of the derived sub-PU TMVP candidates including sub-PU motion information of sub-PUs of the current PU; and
including none or a subset of the derived sub-PU TMVP candidates into a merge candidate list of the current PU.
